(19) United States
(12) Patent Application Publication
(10) Pub. No.: US 2025/0270384 A1
(43) Pub. Date: Aug. 28, 2025

(54) HYALOCLASTITE POLYMERIC FOAM, HYALOCLASTITE MINERAL POLYMERIC FILLER, HYALOCLASTITE POLYMERIC COMPOSITIONS, AND METHOD OF MAKING AND USING SAME

(71) Applicant: Greencraft LLC, Norcross, GA (US)

(72) Inventor: Romeo Ilarian Ciuperca, Atlanta, GA (US)

(73) Assignee: Greencraft LLC, Norcross, GA (US)

(21) Appl. No.: 18/588,915

(22) Filed: Feb. 27, 2024

(51) Int. Cl. C08K 3/40

(52) U.S. Cl. CPC C08K 3/40; C08K 2201/005

(57) ABSTRACT

The invention comprises a product. The product comprises a polymeric material blended with hyaloclastite having a mean volume-based particle size of less than or equal to 150 μm. A process for making the product is also disclosed.

### CROSS-REFERENCE TO RELATED APPLICATIONS

This application claims the benefit of application Ser. No. 63/488,294 filed Mar. 3, 2023.

### FIELD OF THE INVENTION

The present invention relates generally to an additive for polymeric materials. More specifically, the present invention relates to a natural mineral that can be used as an additive to modify the physical properties of a polymeric material. The present invention also relates to a natural material that can be used as a filler for polymeric materials.

### BACKGROUND OF THE INVENTION

There is great interest in the development of fillers for polymeric materials that do not emit toxic compounds during thermal decomposition and that improve physical properties, thermal stability, insulating value, flame spread and fire resistance properties of polymeric foam and other polymeric materials.

Polymeric foam compositions are well known in the art. The most common types of materials used in making foam include polystyrene (expanded or extruded), polyisocyanurate (polyiso), and polyurethane among others. Insulation boards or sheets can be manufactured using any of these materials as well as being used in a variety of applications, such as composite insulating panels, with or without structural properties, insulating concrete forms, etc. These foams boards or panels can be used in building construction, to improve the energy efficiency of the building envelope thereby reducing the cost of heating and cooling, as well as in a variety of industrial and consumer products. Alternatively, these types of foams can be sprayed or foamed in place according to the need of specific applications. Most foam materials use foaming agents that don't use chlorofluorocarbons (CFCs) or hydrochlorofluorocarbons (HCFCs), which are harmful to the earth's ozone layer. Generally speaking, there are two types of foam-in-place insulation: closed-cell and open-cell. Both are typically made with polyurethane. With closed-cell foam, the high-density cells are closed and filled with a gas that helps the foam expand to fill the spaces around it. Open-cell foam cells are not as dense and are filled with air, which gives the insulation a spongy texture. Other available foam insulation materials include: cementitious or phenolic.

Some less common types include icynene foam and tripolymer foam. Icynene foam can be either sprayed or injected, which makes it the most versatile. It also has good resistance to both air and water intrusion. Tripolymer foam—a water-soluble foam—is typically injected into wall cavities and has excellent resistance to fire and air intrusion.

### Types of Insulating Foams.

Polyisocyanurate typically has an insulating value of R-5.6 (RSI-0.99) or slightly better after stabilization—higher values (at least R-7, or RSI-1.23) in stabilized boards. It is less flammable than polyurethane. It is a thermoset plastic typically produced as a foam and used as rigid thermal insulation. The starting materials are similar to those used in polyurethane (PUR) except that the proportion of methylene diphenyl diisocyanate (MDI) is higher and a polyester-derived polyol is used in the reaction instead of a polyether polyol. The resulting chemical structure is significantly different, with the isocyanate groups on the MDI trimerizing to form isocyanurate groups which the polyols link together, giving a complex polymeric structure.

Phenolic injection foam, such as tripolymer foam, has an R value of 5.1 per inch (ASTM-C-177). It is known for its air sealing abilities. Tripolymer foams can be installed in wall cavities that have fiberglass and cellulose in them. It is non-hazardous, is not restricted by depth of application, fire resistant (flame spread 5), has low smoke spread 0 (ASTM-E-84)—will not smoke at all upon direct contact with flame and is a two-hour firewall at a 3.5 in (89 μmm), or normal 2 in×4 in (51 μmm×102 μmm) stud wall, application per ASTM E-199. Tripolymer foams have excellent sound deadening properties, STC 53 (ASTM E413-73); does not echo like other foams; is environmentally friendly; is non-expansive (good for existing homes where interior sheathing is in place) is fully sustainable (i.e., consists of phenolic, a foaming agent, and air); is blown with air (no CFCs, HCFCs or other harmful blowing agents); is nontoxic, even during application; does not shrink or settle; has zero VOC emissions; is chemically inert (no known symptoms of exposure per MSDS); is insect resistant, mold proof and is insoluble in water. Disadvantages: like all foams, tripolymer foam is more expensive than conventional fiber insulations when only comparing per square foot pricing; when you compare price to R value per square foot the price is about the same.

Polystyrene (expanded polystyrene (EPS) and extruded polystyrene (XPS)) is a synthetic polymer made from monomers of the aromatic hydrocarbon styrene. Polystyrene can be solid or foamed. General-purpose polystyrene is clear, hard, and brittle. It is an inexpensive resin per unit weight. It is a poor barrier to oxygen and water vapor and has a relatively low melting point. Polystyrene is one of the most widely used plastics, the scale of its production being several million tons per year. Polystyrene can be naturally transparent, but can be colored with colorants. As a thermoplastic polymer, polystyrene is in a solid (glassy) state at room temperature but flows if heated above about 100° C., its glass transition temperature. It becomes rigid again when cooled. This temperature behavior is exploited for extrusion (as in Styrofoam boards) and also for molding and vacuum forming, since it can be cast into molds with fine detail. Expanded polystyrene (EPS) is a rigid and tough, closed-cell foam with a normal density range of 11 to 32 kg/m³. It is usually white and made from pre-expanded polystyrene beads. The manufacturing process for EPS conventionally begins with the creation of small polystyrene beads. Styrene monomers (and potentially other additives) are suspended in water, where they undergo free-radical addition polymerization. The polystyrene beads formed by this mechanism may have an average diameter of around 200 μm. The beads are then permeated with a “blowing agent”, a material that enables the beads to be expanded. Pentane is commonly used as the blowing agent. The beads are added to a continuously agitated reactor with the blowing agent, among other additives, and the blowing agent seeps into pores within each bead. The beads are then expanded using steam. Extruded polystyrene foam (XPS) consists of closed cells. It offers improved surface roughness, higher stiffness and reduced thermal conductivity. The density range is about 28-34 kg/m³. Extruded polystyrene material is also used in crafts and model building, in particular architectural models. Because of the extrusion manufacturing process, XPS does not require facers to maintain its thermal or physical property performance. Thus, it makes a more uniform substitute for corrugated cardboard. Thermal conductivity varies between 0.029 and 0.039 W/(m·K) depending on bearing strength/density and the average value is ˜0.035 W/(m˜K).

Polyurethane (often abbreviated PUR and PU) refers to a class of polymers composed of organic units joined by carbamate (urethane) links. In contrast to other common polymers, such as polyethylene and polystyrene, polyurethane is produced from a wide range of starting materials. This chemical variety produces polyurethanes with different chemical structures leading to many different applications. These include rigid and flexible foams, varnishes and coatings, adhesives, electrical potting compounds, and fibers, such as spandex, and polyurethane laminate (PUL). Foams are the largest application accounting for 67% of all polyurethane produced in 2016. A polyurethane is typically produced by reacting an isocyanate with a polyol. Since a polyurethane contains two types of monomers, which polymerize one after the other, they are classed as alternating copolymers. Both the isocyanates and polyols used to make a polyurethane contain two or more functional groups per molecule. Global production in 2019 was 25 μmillion metric tonnes, accounting for about 6% of all polymers produced in that year.

Icynene is a trademarked brand of isocyanate open-cell spray foam from Huntsman Building Solutions. The classic version has a thermal resistance (R value) of 3.7 per inch and other versions have even higher values. The formula also includes a flame retardant. Icynene uses water for its spray application and the chemical expansion is caused by the carbon dioxide generated by the reaction between the water and isocyanate material. Icynene will expand up to 100 times its original size within the first 6 seconds of being applied. Icynene contains no ozone-depleting substances such as CFCs, HFCs, HCFCs. Icynene contains volatile organic compounds (VOCs). Icynene will not emit any harmful gases once cured. Icynene has a global warming potential of 1 and flammability is relatively low. Icynene maintains its efficiency with no loss of R-value for the life of the install. Icynene is more expensive compared to traditional insulation methods. Any potential for harm is primarily during the installation phase and particularly for installers. The manufacture of icynene involves many toxic petrochemicals.

Foam insulation blocks all three forms of heat transfer:

A. Conductive heat transfer. The flow of thermal energy through a substance from a higher to a lower temperature region. Foam thermoset plastics reduce conductive heat transfer due in part to having very loose molecular bonds. In addition the cells of installed spray foam are either filled with air in the case of open cell foam or HFCs (365mfc, 227ea, 245fa) or H(C)FOs (1336mzz(Z), 1233zd(E)) in closed cell foam.

B. Radiant heat transfer. The process by which heat energy in the form of light (usually IR unless the substrate is hot enough to glow in the visible range) is emitted more strongly by warm surfaces and absorbed by other materials especially those of low IR reflectivity (think matte black finish). Radiant heat transfer does not require a medium. Foam insulation materials, such as spray foam insulation, are opaque to thermal radiation, like most solid materials.

C. Convective heat transfer. Heat which is created elsewhere that is transported by means of a liquid or a gas. Spray foam insulation's most important attribute is the ability to air seal creating a custom airtight envelope within a building structure. The added benefit to air sealing is the ability to block convective heat transfer from interior to exterior during heating months and vice versa during cooling months, as the heat cannot escape through gaps in the buildings envelope without the aid of air movement from infiltration as a means of transport.

It would be desirable to provide an additive or filler for polymeric materials that can affect the physical properties thereof.

### SUMMARY OF THE INVENTION

The present invention satisfies the foregoing needs by providing an improved natural mineral additive for polymeric material.

In one disclosed embodiment, the present invention comprises a product. The product comprises a polymeric material combined with hyaloclastite having a volume-based mean particle size of less than or equal to 100 μm.

In another disclosed embodiment, the present invention comprises a product. The product comprises a polymeric material combined with hyaloclastite having a volume-based mean particle size of less than or equal to 100 μm, wherein the hyaloclastite is basaltic hyaloclastite or intermediate basaltic hyaloclastite.

In another disclosed embodiment, the present invention comprises a process. The process comprises combining hyaloclastite with an uncured or unset polymeric material to thereby form a uniform mixture thereof, wherein the hyaloclastite has a volume-based mean particle size of less than or equal to 100 μm.

In yet another disclosed embodiment, the present invention comprises a process. The process comprises combining hyaloclastite with a thermoplastic polymeric material, wherein the hyaloclastite has a volume-based mean particle size of less than or equal to 100 μm and extruding the mixture.

In another disclosed embodiment, the present invention comprises a process. The process comprises combining hyaloclastite with an uncured or unset polymeric material to thereby form a uniform mixture thereof, wherein the hyaloclastite has a volume-based mean particle size of less than or equal to 100 μm and curing or setting the polymeric material.

In a further disclosed embodiment of the present invention, the invention comprises a process. The process comprises combining hyaloclastite with an uncured or unset polymeric material to thereby form a uniform mixture thereof, wherein the hyaloclastite has a volume-based mean particle size of less than or equal to 100 μm and wherein the hyaloclastite is basaltic hyaloclastite or intermediate basaltic hyaloclastite.

Accordingly, it is an object of the present invention to provide an improved natural mineral additive for polymeric materials.

Another object of the present invention is to provide an improved filler for polymeric materials.

Another object of the present invention is to provide an improved natural mineral additive for polymeric materials that can modify the physical properties thereof.

A further object of the present invention is to provide a natural mineral additive for polymeric materials that improves the insulating properties thereof.

Another object of the present invention is to provide a natural mineral additive for polymeric materials that improves the strength properties thereof.

Another object of the present invention is to provide a natural mineral additive or filler for polymeric materials that is non-toxic.

These and other objects, features and advantages of the present invention will become apparent after a review of the following detailed description of the disclosed embodiments and the appended claims.

### BRIEF DESCRIPTION OF THE DRAWINGS

FIG. 1 is a flow diagram of a disclosed embodiment of a natural mineral processing plant in accordance with the present invention.

FIG. 2 is a flow diagram of another disclosed embodiment of a natural mineral processing plant in accordance with the present invention.

FIG. 3 is an illustration of how to determine the circle fit of an irregularly shaped particle.

FIG. 4 is an illustration of how to determine the circularity of an irregularly shaped particle.

### DETAILED DESCRIPTION OF THE DISCLOSED EMBODIMENTS

Hyaloclastite, or lave quenched by water of basaltic or intermediate-basaltic chemistry, has high thermal stability with softening temperature of up to T=1200° C. It has been discovered in accordance with the present invention that when ground to a fine powder form hyaloclastite can be used as a filler which strengthens and reduces the flammability of polymeric materials. Hyaloclastite of basaltic or intermediate-basaltic chemistry also improves the thermal stability, heat insulation value and fire resistance of polymeric materials. Hyaloclastite when ground to a fine powder provides good polymer-filler interactions, including adsorption of polymer chains on the hyaloclastite or lava quenched by water particle high surface area. Given the high thermal capacity of hyaloclastite, by absorbing significant amounts of heat, hyaloclastite acts as a thermal shield that protects the composite from both degradation and destruction processes when exposed to high temperature. Thermally stable hyaloclastite of basalt or intermediate-basaltic chemistry, does not undergo any thermal transformations, positively influences the structure of the boundary layer formed during thermal decomposition and combustion, effectively impeding the mass and energy flow between a hyaloclastite filler-based foam and a flame.

Hyaloclastite or lave quenched by water of basaltic or intermediate-basaltic chemistry has a hardness of 6-7 on the Mohs scale and when in a fine powder to be used as a filler improves the flexural and compressive strength of polymeric materials as well as other physical properties.

Hyaloclastite is a tuff-like breccia typically rich in black volcanic glass, formed during volcanic eruptions under water, under ice or where subaerial flows reach the sea or other bodies of water when lava is quenched by water. It has the appearance of angular fragments sized from approximately a millimeter to a few centimeters. Larger fragments can be found up to the size of pillow lava as well. Several minerals are found in hyaloclastite masses including, but not limited to, sideromelane, tachylite, palagonite, olivine, pyroxene, magnetite, quartz, hornblende, biotite, hypersthene, feldspathoids, plagioclase, calcite and others. Fragmentation can occur by both an explosive eruption process or by an essentially nonexplosive process associated with the spalling of pillow basalt rinds by thermal shock or chill shattering of molten lava. The water-quenched basalt glass is called sideromelane, a pure variety of glass that is transparent, and lacks the very small iron-oxide crystals found in the more common opaque variety of basalt glass called tachylite. In hyaloclastite, these glassy fragments are sometimes surrounded by a matrix of yellow-to-brown palagonite, a wax-like substance that forms from the hydration and alteration of the sideromelane and other minerals. Depending on the type of lava, the amount and pressure of the water quenching the lava, the rate of quenching or cooling and the amount of lava fragmentation, the particle of the volcanic glass (sideromelane) can be mixed with other volcanic rocks or crystalline minerals, such as olivine, pyroxene, magnetite, quartz, plagioclase, calcite and others. Alternatively, or additionally, the composition of the lava may contain crystals within the magma chamber prior to the volcanic eruption causing these crystals to be suspended in the lava matrix regardless of the amount or type of water quenching during the eruptions process. Lava quenched by water, regardless of the various percentages of amorphous or crystalline has different properties than lava of the same chemistry from a subaerial eruption where lave cools slowly over time and may contain similar types of crystalline minerals. In other words, rapidly cooled lava quenched by water has more desirable properties for the present invention than lava from a subaerial eruption that cools slowly over time. As such for the purpose of this invention the “lava quenched by water” description is interchangeable with the term “hyaloclastite”.

Hyaloclastite is usually found within or adjacent subglacial volcanoes, such as tuyas, which is a type of distinctive, flat-topped, steep-sided volcano formed when lava erupts under or through a thick glacier or ice sheet. Hyaloclastite ridges are also called tindars and subglacial mounds are called tuyas or mobergs. They have been formed by subglacial volcanic eruptions during the last glacial period. A subglacial mound is a type of subglacial volcano. This type of volcano forms when lava erupts beneath a thick glacier or ice sheet. The magma forming these volcanoes was not hot enough to melt a vertical pipe through the overlying glacial ice, instead forming hyaloclastite and pillow lava deep beneath the glacial ice field. Once the glacier retreated, the subglacial volcano was revealed, with a unique shape as a result of its confinement within the glacial ice. Subglacial volcanoes are somewhat rare worldwide, being confined to regions that were formerly covered by continental ice sheets and also had active volcanism during the same period. Currently, volcanic eruptions under existing glaciers may create hyaloclastite as well.

Sometimes a subglacial or subaquatic eruption may produce a release of volcanic ashes that are ejected into the atmosphere which can then land back on the ground. At times a fine volcanic particle size may be called a “volcanic ash” by different professionals in the geological field even though the ash definition may be debatable. It is also possible that a subglacial or subaquatic eruption may have been produced by a magma with high volume of gas entrapped in the lava. The high volume of gas exsolution may create a mineral particle with very high porosity or vesicular structure and bulk density similar to scoria or pumice.

Natural volcanic minerals, such as lava quenched by water or hyaloclastite, can be classified based on the amount of silica content as: basaltic (less than 53% by weight SiO₂), intermediate-basaltic (approximately 53-57% by weight SiO₂), or silicic such as andesitic (approximately 57-63% by weight SiO₂), dacitic (approximately 63-69% by weight SiO₂), or rhyolitic (greater than 69% by weight SiO₂). However, for the purpose of this invention the basaltic range starts at 40% SiO₂ and the andesitic range ends at 65% SiO₂.

Basaltic lava quenched by water or hyaloclastite, contains generally 40% to 53% by weight silica (SiO₂) contained in an amorphous or crystalline form or a combination thereof comprising essentially calcic plagioclase feldspar and pyroxene (usually Augite), with or without olivine. In addition to silica, basaltic lava quenched by water or hyaloclastite, generally comprises approximately 10 to approximately 18 percent by weight Fe₂O₃, approximately 6 to approximately 18 percent by weight CaO, approximately 5 to approximately 15 percent by weight MgO and other elements in various percentages.

Intermediate basaltic lava quenched by water or hyaloclastite, generally comprises approximately 53 to approximately 57 percent by weight silica (SiO₂) content. In addition to silica, intermediate basaltic lava quenched by water or hyaloclastite generally comprises approximately 5 to approximately 10 percent by weight Fe₂O₃, approximately 6 to approximately 10 percent by weight CaO, approximately 3 to approximately 10 percent by weight MgO and other elements in various percentages. Basaltic or intermediate-basaltic lava quenched by water or hyaloclastite may also contain quartz, hornblende, biotite, hypersthene (an orthopyroxene) and feldspathoids. The average specific density of basaltic or intermediate-basaltic lava quenched by water or hyaloclastite, is approximately 2.5-3.0 gm/cm³, preferably 2.6-2.9, and more preferably 2.75-2.85.

The crystalline minerals contained within basaltic or intermediate-basaltic or andesitic volcanic lava quenched by water or hyaloclastite, when ground to a small particle size have good filler properties for used in polymeric materials. Therefore, a natural mineral filler from a basaltic, intermediate-basaltic or andesitic mineral source is far more desirable to be used as natural mineral filler in accordance with the present invention than a natural mineral filler from a dacitic or rhyolitic chemistry source.

As used herein, the term “hyaloclastite” shall mean lava quenched by water or hyaloclastite of basaltic or intermediate basaltic composition; i.e., all lava quenched by water or hyaloclastites of basaltic or intermediate basaltic composition, or its crystalline or amorphous compositions or combination thereof, with an amorphous content of 0-100% and a crystalline content of 0-100% wherein the crystalline matrix is comprised of various types of crystals, unless otherwise designated.

TABLE 1
Desirable chemical compositions for a natural mineral filler for polymeric materials

| Elements | LS36-10 | TDR | SND | AB | BKP | PVT | RDF | THR | VCR | PTR |
|---|---|---|---|---|---|---|---|---|---|---|
| SiO₂ | 45.20 | 45.00 | 47.70 | 47.20 | 46.36 | 48.50 | 50.60 | 52.85 | 54.94 | 60.39 |
| Al₂O₃ | 14.09 | 17.60 | 15.33 | 12.49 | 11.96 | 15.40 | 15.00 | 14.53 | 14.87 | 13.05 |
| Total SiO_{2,} | 59.29 | 62.60 | 63.03 | 59.69 | 58.32 | 63.90 | 65.60 | 67.38 | 69.81 | 73.44 |
| Al₂O₃ | | | | | | | | | | |
| CaO | 14.77 | 12.70 | 11.51 | 11.51 | 9.68 | 9.37 | 9.16 | 8.94 | 8.84 | 6.69 |
| MgO | 6.11 | 7.27 | 10.89 | 11.06 | 5.50 | 6.57 | 7.78 | 4.94 | 4.93 | 6.37 |
| FeO | 13.07 | 12.90 | 12.75 | 12.04 | 15.38 | 13.00 | 10.20 | 12.03 | 9.85 | 7.21 |
| Total CaO, | 33.95 | 32.87 | 35.15 | 34.61 | 30.56 | 28.94 | 27.14 | 25.91 | 23.62 | 20.27 |
| MgO, FeO | | | | | | | | | | |
| Na₂O | 3.22 | 1.83 | 1.58 | 1.72 | 2.60 | 3.40 | 3.34 | 2.69 | 2.63 | 2.23 |
| K₂O | 1.12 | 0.21 | 0.21 | 0.40 | 0.70 | 1.14 | 1.48 | 0.76 | 0.86 | 2.27 |
| Total Alkali | 4.34 | 2.04 | 1.79 | 2.12 | 3.30 | 4.54 | 4.82 | 3.45 | 3.49 | 4.50 |

Different volcanic minerals, including lava quenched by water or hyaloclastites, have different amounts of amorphous glass and crystalline content. The oxides shown in Table 1 above is a method of determining the chemical composition and may not be a reflection of actual free oxides present within the matrix by themselves. The elements of the oxides are or may be part of complex formula of amorphous or microcrystalline structure or a combination thereof.

Olivine group minerals, belonging to the isolated tetrahedra silicate subclass, all have similar atomic arrangements. By far, the most important mineral of this group is called olivine. In contrast with some of the other silicates previously discussed, olivine chemistry is quite simple. Its general formula is (Mg, Fe, Ca, Mn)₂SiO₄ but Mn and Ca are often omitted because they are normally minor components.

Pyroxenes contain many different elements, but all pyroxenes have the general formula (Ca, Na, Mg, Fe)(Mg, Fe, Al)(Si, Al)₂O₆. The most common pyroxenes are close to Ca(Mg, Fe)Si₂O₆ or (Mg, Fe)₂Si₂O₆ in composition.

Amphiboles and pyroxenes are closely related minerals that commonly coexist. Both are chain silicates, but the atomic arrangement in amphiboles is more complex than in pyroxenes. Like pyroxenes, amphibole chemistry is highly variable and yields many different end member formulas. Also, like the pyroxenes, amphiboles fall into two main series: the orthoamphibole series and the clinoamphibole series. The amphiboles general formula is (K, Na)₀₋₁(Ca, Na, Mg)₂(Mg, Fe, Al)₅(Si, Al)₈O₂₂(OH)₂

Feldspars are the most abundant minerals in the Earth's crust. Their compositions vary but may be described with the general formula (Ca, Na, K)(Si, Al)₄O₈. Feldspar structures are based on SiO₄ and AlO₄ tetrahedra linked to form a three-dimensional framework. They form two series that share one end-member composition: the alkali feldspar series (mainly NaAlSi₃O₈-KAlSi₃O₈) and the plagioclase (mainly NaAlSi₃O₈—CaAl₂Si₂O₈) series, alkali feldspars range in composition from albite (NaAlSi₃O₈) to orthoclase (KAlSi₃O₈). They also contain minor amounts of anorthite (CaAl₂Si₂O₈). Plagioclase feldspars are mostly solid solutions of albite (NaAlSi₃O₈) and anorthite (CaAl₂Si₂O₈). They commonly contain lesser amounts of orthoclase (KAlSi₃O₈), especially at high temperatures

K-rich feldspar may be either of three polymorphs: sanidine, orthoclase, or microcline. The three differ in the way SiO₄ and AlO₄ tetrahedra are distributed in their structures. Sanidine, the high-temperature polymorph, is most disordered; microcline, the low-temperature polymorph, is most ordered. Orthoclase has intermediate and somewhat variable ordering. Na-rich feldspar, too, has different polymorphs; they include monalbite at high temperature and low-albite at low temperature

Orthoclase comes from the Greek word orthos (right angle) and klasis (to break), referring to this mineral's perpendicular cleavages. The formula is KAlSi₃O₈. The luster, hardness and color of orthoclase may be similar to other feldspars, but (in contrast with plagioclase) orthoclase is frequently tan, pink, or flesh colored (plagioclase is usually white). Orthoclase has cleavage planes that meet at about 90 degrees, like other feldspars, but orthoclase does not show twin striations like plagioclase does.

Chemical compositions as reported herein are measured by the XRF (X-ray fluorescence) method. This is a non-destructive analytical technique used to determine the elemental composition of materials. XRF analyzers determine the chemistry of a sample by measuring the fluorescent (or secondary) X-ray emitted from a sample when it is excited by a primary X-ray source. Each of the elements present in a sample produces a set of characteristic fluorescent X-rays (“a fingerprint”) that is unique for that specific element, which is why XRF spectroscopy is an excellent technology for qualitative and quantitative analysis of material composition. The chemical analysis reported herein is the total oxides scan.

Sample preparation for XRF can be achieved using either of two distinct methods: a pressed powder and a fused glass disk. Pressed powder specimens are typically ground in a tungsten carbide ring and puck mill with a binding agent to reduce the particle size and provide a packed powder mount that will remain intact for transport and analysis. The advantages of this preparation method include the simplicity and better detection limits while disadvantages include what is known as the “mineralogical effect”, which requires a similar matrix between a bracketed calibration and unknown specimens for the calibrations to be valid.

Minerals with basaltic and intermediate-basaltic chemistry are the most thermally stable minerals. As the amount of silica increases, the thermal expansion of the mineral increases. Therefore, minerals with basaltic and intermediate-basaltic chemistry are most desirable to be used as a mineral filler for polymers to improve thermal stability, flame spread and fire resistance properties.

TABLE 2
Thermal expansion of rocks for the temperature interval 20-100° C.

| | Volumetric |
|---|---|
| | thermal |
| | expansion¹ |
| Rock type | (10⁻⁵ per ° C.) |
| Granite, rhyolite | 2.40 |
| Diorite, andesite | 2.10 |
| Gabbro, basalt | 1.60 |
| Sandstone | 3.00 |
| Quartzite | 3.30 |
| Limestone | 2.40 |
| Marble | 2.10 |
| Slate | 2.70 |

¹Mean volumetric thermal expansion, (X = (1/V0) (A V/A T), in units of 10⁻⁵ per ° C., from Skinner (1966)

Hyaloclastite, or lava quenched by water, with a basaltic or intermediate-basaltic chemical compositions is an inert and very stable natural mineral with high mechanical and thermal resistance as compared with all other mineral types. Polymeric materials reinforced with hyaloclastite, or lava quenched by water, with basaltic or intermediate basaltic composition in powder form has enhanced properties such as improved rigidity, hardness, and thermal resistance. Hyaloclastite, or lava quenched by water, mineral filler contributes to the decrease of the heat release rate, indicating its usefulness as a flame-retardant material thus improving flammability and fire resistance of the polymeric materials using this type mineral filler.

TABLE 3
Thermal Conductivity of Some Geosilicate
Crystals, Glasses and Melts at 1 bar

| | | Thermal | |
|---|---|---|---|
| | Temperature | Conductivity | |
| Composition and state | (° C.) | (W/mK) | Source* |
| Olivine (Fo90) | 800 | 2.69 | (1) |
| | 1400 | 2.18 | (1) |
| Forsterite (Olivine) | 400 | 2.47 | (1) |
| | 800 | 1.84 | (1) |
| | 1400 | 1.59 | (1) |
| Orthopyroxene (Bronzite) | 0 | 4.62 | (1) |
| | 300 | 3.05 | (1) |
| Clinopyroxene (Diopside) | 20 | 4.27 | (1) |
| Obsidian (rhyolite glass) | 0 | 1.34 | (1) |
| | 300 | 1.67 | (1) |
| | 500 | 1.89 | (1) |
| Basalt glass (Hyaloclastite) | 0 | 1.15 | (1) |
| | 300 | 1.48 | (1) |
| SiO₂ (glass) | 600 | 1.76 | (1) |
| | 1230 | 1.87 | (1) |
| Plagioclase (Albite glass) | 25 | 1.37 | (2) |
| | 800 | 1.56 | (2) |
| Plagioclase (Anorthite glass) | 25 | 1.13 | (2) |
| | 800 | 1.43 | (2) |
| Pyroxene (Augite/Diopside | 25 | 1.24 | (2) |
| glass) | 800 | 1.46 | (2) |

*(1) Clark (1966); (2) Hofmeister et al. (2009);

Minerals with basaltic and intermediate-basaltic chemistry have the lowest thermal conductivity, as such making them the best mineral fillers to improve polymeric material properties. As the amount of silica increases, so does the thermal conductivity of the mineral increase. Also, minerals with the same chemical composition found in an amorphous state generally have a lower thermal conductivity than the same mineral in a crystalline form. The type of crystals found in a crystalline mineral also seem to indicate different thermal conductivity coefficient. Therefore, minerals with basaltic and intermediate-basaltic chemistry are most desirable to be used as polymeric mineral fillers to improve thermal conductivity and minerals in amorphous state are more desirable as well as flame spread and fire resistance properties. However, based on the desired property outcome these parameters have to be balanced toward the end goal. Therefore, in accordance with the present invention the lower the silica content the better the mineral is to be used as a filler to improve polymeric materials properties.

Hyaloclastite, or lava quenched by water, of basaltic or intermediate-basaltic chemistry is the hardest volcanic mineral to crush, grind or mill. As the SiO₂ increases, the hardness decreases. The hardness of the mineral is a determining factor in how the mineral fractures or breaks-up into smaller particles. A hard mineral breaks up in a more angular, rough particle shapes with many more concavities on the surface and generally in a more elongated shapes rather than a more circular shape. We call this particle shape type a complex irregular polyhedron with a multitude of convex and concave planes oriented at random angles and having random sizes and shapes but generally of a more elongated rather than spherical shape. The irregular complex polyhedron can also have one or more vesicular cavities connected to the surface thereof. We call this a rough particle surface. In other words, the hyaloclastite, or lava quenched by water, when ground to a small particle size, such as a powder, the exterior surface of the particle's rough surface allows for better adsorption and adhesion of the polymer to the mineral filler thereby improving physical properties of the polymer material containing such hyaloclastite mineral filler. The rougher and more irregular the polyhedral surface of the individual particles, and the more micro or nano cavities on the surface, the better the physical performance of the polymeric foam or plastic product.

Hyaloclastite, or lava quenched by water, of basaltic or intermediate-basaltic chemistry is the hardest volcanic mineral to crush, grind or mill. As the SiO₂ increases, the hardness decreases. The hardness of the mineral is a determining factor in how the mineral fractures or breaks-up into smaller particles. A hard mineral breaks up in a more angular, rough particle shapes with many more concavities on the surface and generally in a more elongated shapes rather than a more circular shape. We call this particle shape type, a complex irregular polyhedron with a multitude of convex and concave planes oriented at random angles and having random sizes and shapes but generally of a more elongated rather than isometric prism or spherical shape such as the type of the particle shape of current rubbers fillers. The irregular complex polyhedron can also have one or more vesicular cavities connected to the surface thereof. We call this a rough particle surface. A rougher particle will have a greater surface area compared to a particle with a smoother surface. A particle of the same size with more cavities or pores will have an even greater surface area than a particle of the same size without cavities or pores. In other words, hyaloclastite, or lava quenched by water, when ground to a small particle size, such as a powder, the exterior surface of the particle's rough surface allows for better adsorption and adhesion of the polymeric material to the mineral filler thereby improving physical properties of the polymeric material containing such hyaloclastite mineral filler while using a filler of greater particle size than for example other types of mineral filler such a carbonates or mica. The rougher and more irregular the polyhedral surface of the individual particles, and the more micro or nano pores or cavities on the surface, the better the physical performance of the polymeric coatings, foam or plastic products.

The significance of particle shape in many industrial materials is frequently disregarded or undervalued. However, the particle shape and its properties play a key role and it is a key feature of the present invention. It is well known that the specific type of breakage affects the particle shape of mill products. For example, massive fracture generally leads to a non-spherical particle, which has sharp edges exposed at the intersection of progressive cracks, whereas attrition mode makes particles round by chipping of the edges and corners or abrasing of the surface. As particle sizes and applied stresses often follow normal distributions, it is very natural to obtain a distribution of product shapes.

Therefore, milling conditions that use an appropriate breakage mode play a crucial role in controlling the morphology of the final product. Moreover, the desired morphology of the filler particle in accordance with the present invention requires choosing the right device to achieve the desired particle shape. For example, roller press mills, ring roll mills, and hammer mills have been reported to produce mill products with decreasing particle roundness. It is this inventor's observation that particles with high circularity and low aspect ratio values can be produced by using a ball mill while particles with low circularity and high aspect ratio values can be obtained by using a roller mill. In addition, high pressure grinding roll (HPGR) mills can further increase the high aspect ratio of the particle size by fracturing mineral in a fiber like shape. In other words retention systems such as ball mills create more rounded particles, whereas single-pass devices such as roll crushers typically produce more elongated and angular particles. In addition, the following specific shapes of particles can be obtained by using specific crushers and mills: cubical products from an impact mill (one pass), cubical products from a roll crusher, sharp products from a gyratory crusher, spherical abrasive particles by a cyclone with walls, round products by autogenous grinding, the highest elongated particles from rod mill processing compared to the ball and autogenous mill. In addition, it has been reported that materials having globular, cigar-shaped, and flaky particles can be prepared by grinding using a hammer, disc, ball mill and vibratory pulverizer, respectively. Alternatively, hyaloclastite, or lava quenched by water, filler in accordance with the present invention can be processed in multiple stages. As an example, the initial raw mineral can be placed first in an HPGR, roller plate mill or rod mill where a more elongated angular shape particle is fractured and brought to a desired particle size. The size and shape of this particle size may be suitable for applications where a more plate-like or elongated shape is desired. Subsequently, the particles processed by the HPGR, roller plate mill or rod mill can be further processed in a ball mill or impact mill both to reduce the particle size or to change the particle shape to a lower aspect ratio, or a more rounded or blocky shape. However the irregular polyhedral shape of the initial HPGR, roller plate mill or rod mill fracture with its multitude of convex and concave planes are retained as the ball mill works to create a more rounded particle shape. As a more specific example the hyaloclastite, or lava quenched by water, raw mineral can be placed first in an HPGR, roller plate mill or rod mill where a more elongated, angular shape particle is fractured and brought to a 40-150 micron mean particle size. The size and shape of this particle size can be suitable for applications where a more plate-like or elongated shape is desired. Subsequently, the particles processed by the HPGR, roller plate mill or rod mill with a mean particle size of a 40-150 micron is further processed in a ball mill, jet mill or impact mill both to reduce the particle size or to change the particle shape to a lower aspect ratio, or a more rounded or blocky shape to a mean particle size of 0.1-20 micron. However, the irregular polyhedral shape of the initial HPGR, roller plate mill or rod mill fracture with its multitude of convex and concave planes are retained as the ball mill or jet mill works to create a more rounded particle shape.

TABLE 4
Mohs scale Hardness of minerals:

| Mineral | Hardness |
|---|---|
| Diamond | 10 |
| Spinel | 8 |
| Quartz | 7 |
| Zircon | 6.5-7.5 |
| Peridot/olivine | 6.5-7 |
| Steel File | 6.5 |
| Basaltic Hyaloclastite | 6-7 |
| Plagioclase Feldspar | 6-6.5 |
| Orthoclase Feldspar | 6-6.5 |
| Titanium Oxide | 6 |
| Clinopyroxene | 5-7 |
| Silica (Precipitated) | 5.5 |
| Window Glass | 5-5.5 |
| Diopside/pyroxene | 5-6 |
| Obisidian | 5-5.5 |
| Steel Knife Blade | 5.1 |
| Zinc Oxide | 4.5 |
| Wollastonite | 4.5 |
| Dolomite | 3.5-4.5 |
| Copper Penny | 3.5 |
| Calcite/Limestone | 3-4 |
| Barium Sulfate | 3-3.5 |
| Mica | 2.5-4 |
| Hyalosyte | 2.5 |
| Carbon Black | 2-3 |
| Gypsum | 2 |
| Kaolin | 2 |
| #2 Pencil Lead | 1 |
| Talc 1 | 1 |

Table 4 above shows some minerals currently used as fillers in the polymer industry and mineral fillers in accordance with the present invention (shown as underlined). Note that all other mineral fillers currently used in the polymeric industry are softer than the hyaloclastite filler in accordance with the present invention.

The hyaloclastite of basaltic or intermediate basaltic chemistry in either amorphous form, crystalline form or a combination thereof are very hard minerals and when fractured by the grinding process are suitable to create a particle shape with the desired properties in accordance with the present invention as described above.

Different types of milling or crushing equipment can create a more or less rough particle surface and the roughness also depends on the particle size and the time it is processed in the mill. A roller or rod mill tends to create a more elongated particle shape while a ball mill tends to create a rounder particle shape. A larger particle size tends to be more elongated versus a fine particle size that tends to be more round. The inventor has discovered that the surface and shape properties described above are a function of the hyaloclastite, or lava quenched by water, of the basaltic and intermediate basaltic chemistry in accordance with the present invention. Hyaloclastite, or lava quenched by water, with chemistry of higher silica content are gradually softer, requiring less energy to process or crush, and generally creating a more rounded particle shape with less polyhedral planes and generally a more convex rather than concave polyhedral shape. A more rounded particle shape has less surface area, the surface area is smoother instead of rough and as a result the polymer absorbs and/or adsorbs less efficiently and the chemical or physical bond between the polymer and the mineral filler is less strong. A more isometric prismatic or rounded particle shape has less surface area, the surface area is smoother instead of rough resulting in less surface area for the same particle size. This requires a filler with a much finer particle size that has the equivalent surface area of a much coarser particle that has the same surface area due to a rougher surface. The result is that polymers absorbs and/or adsorbs less efficiently and the chemical or physical bond between the polymer and the mineral filler is less strong or that a much finer particle size filler is needed to accomplish the same result.

The type of grinding aid used in the milling process will reduce the energy required to process the mineral filler in accordance with the present inventions. A grinding aid has to be selected as to be compatible with the polymer application. Generally, the use of a grinding aid will produce a slightly more rounded particle shape, however the filler in accordance with the present invention is still a generally elongated and rough particle shape of irregular polyhedron shape with convex and concave planes randomly oriented and displaced. This can be helpful when the hyaloclastite filler is intended to be used as a nucleating agent or when used in the production of expanded polystyrene foam beads. It may also be desirable to use a grinding aid to create a slightly more rounded particle shape filler with better flow and viscosity properties compared to particles produced without the use of a grinding aid.

Similarly, fillers made from a softer mineral such as limestone, talc, mica and the like, when ground into a powder tend to be more rounded shapes, requiring less energy to process or crush, and generally with less polyhedral planes and cavities. We call these a more regular polyhedron, if not a more spherical shape. These particle shapes generally have a more convex than concave polyhedral shape, being more rounded and spherical. A more rounded particle shape has less surface area, the surface area is smoother and as a result the polymer absorbs and/or adsorbs or bonds less efficiently and the chemical or physical bond between the mineral filler and polymeric material is less strong. This is why most common fillers used in the polymeric industry generally decrease rather than increase physical properties of polymeric foams or plastics containing them.

Alternatively, the hyaloclastite, or lava quenched by water, with basaltic or intermediate-basaltic chemistry can be fractured in smaller particles to achieve desired properties as described above using high-powered microwave treatment. As an example, hyaloclastite, or lava quenched by water, can be fed by a conveyer belt into a microwave fluid bed dryer or oven.

Below are examples of hyaloclastite filler of basaltic chemistry processed in accordance with the present invention. The table shows the measurement of the following properties using a FlowCam 8000 by Fluid Imaging Technologies of Scarborough ME, USA: diameter, circle fit, circularity, roughness, aspect ratio, length, width, geodesic aspect ratio, geodesic length and geodesic thickness. The terms are defined as follows:

Diameter (Mean): is the average of the Diameter (ABD) (Area Based Diameter) and the Diameter (ESD) (Equivalent Spherical Diameter) where the (Area Based Diameter): is the diameter based on a circle with an area that is equal to the ABD Area and the (Equivalent Spherical Diameter) is the Mean value of 36 feret measurements where the Feret Measurement: The perpendicular distance between parallel tangents touching opposite sides of the particle. VisualSpreadsheet makes 36 μmeasurements for each particle, one each 5 degrees between −90 degrees and +90 degrees. (real>0) and the Area (ABD) is the Number of pixels in the thresholded (binary) greyscale image converted to a measure of area by use of the calibration factor. (real>0).

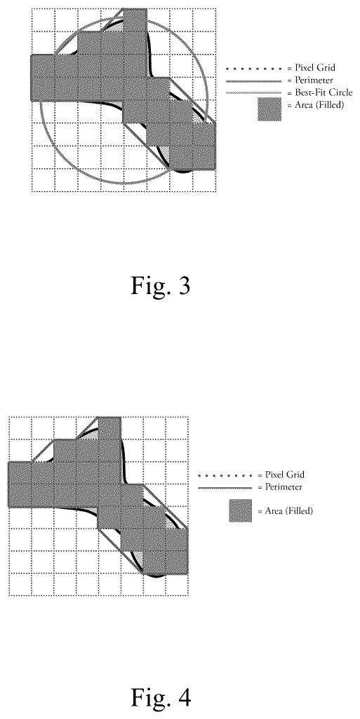

Circle Fit: deviation of the particle edge from a best-fit circle, normalized to the range [0,1] where a perfect fit has a value of 1. (real [0, 1]; 1 is the value for a perfect circle; values near zero are for particles that are not at all circular). See FIG. 3.

Circularity: a shape parameter computed from the perimeter and the (filled) area. A circle has a value of 1.0. Circularity is the inverse of Compactness. Formula: (4×π×Area)/Perimeter². (real [0,1])=Pixel Grid=Perimeter=Best-Fit Circle=Area (Filled). See FIG. 4.

Roughness: a measure of the unevenness or irregularity of a particle's surface—the ratio of perimeter to convex perimeter. (real≥1; 1 is the value for a filled shape with convex perimeter; larger values are for particles that have interior holes and/or a non-convex perimeter).

Aspect Ratio: the ratio of the lengths of the axes of the Legendre ellipse of inertia of the particle. The Legendre ellipse of inertia is an ellipse with its center at the particle's centroid, and with the same geometrical moments, up to second order, as the original particle area. A circle has the value 1.0 as does a square. Values near zero are for particles that are long and thin. (real [0, 1]) Reference: ISO 9276-6:2008.

Length: the maximum value of 36 feret measurements. (real>0) where the Feret Measurement: The perpendicular distance between parallel tangents touching opposite sides of the particle. VisualSpreadsheet makes 36 μmeasurements for each particle, one each 5 degrees between −90 degrees and +90 degrees. (real>0).

Width: the minimum value of 36 feret measurements. (real>0) where the Feret Measurement: The perpendicular distance between parallel tangents touching opposite sides of the particle. VisualSpreadsheet makes 36 μmeasurements for each particle, one each 5 degrees between −90 degrees and +90 degrees. (real>0).

Geodesic Aspect Ratio: the ratio of Geodesic Thickness to Geodesic Length. Elongation is the inverse of this ratio. (real [0, 1]).

Geodesic Length and Geodesic Thickness: values obtained by modeling the particle as a rectangle and computing length and thickness by solving the equations:

Area=Geodesic Length×Geodesic Thickness

Perimeter=2×(Geodesic Length+Geodesic Thickness) where Area is filled area and Perimeter is the length of the particle edge not including the lengths of edges of holes in the particle. (real>0).

TABLE 5
Example of basaltic hyaloclastite ground in a ball mill to a volume-based mean
particle size of 12 micron with the particle properties in subranges as shown.

| Particle | | | | | | | | Geodesic | | |
|---|---|---|---|---|---|---|---|---|---|---|
| Size | Diameter | Circle | Circu- | Rough- | Aspect | | | Aspect | Geodesic | Geodesic |
| Range | (Mean) | Fit | larity | ness | Ratio | Length | Width | Ratio | Length | Thickness |
| 0.75-1 | 0.9432 | 0.7899 | 0.7357 | 1.4152 | 0.5590 | 1.3830 | 0.7131 | 0.6377 | 1.9890 | 1.0068 |
| micron | | | | | | | | | | |
| 1-2 | 1.4133 | 0.8473 | 0.8864 | 1.2962 | 0.7802 | 1.8962 | 1.2111 | 0.8610 | 2.3879 | 1.8489 |
| micron | | | | | | | | | | |
| 2-4 | 2.8400 | 0.8433 | 0.8891 | 1.1967 | 0.8225 | 3.5624 | 2.4154 | 0.9180 | 3.6863 | 3.2384 |
| micron | | | | | | | | | | |
| 4-8 | 5.2062 | 0.7322 | 0.8235 | 1.1436 | 0.7094 | 6.6720 | 4.1146 | 0.8709 | 6.1264 | 4.9897 |
| micron | | | | | | | | | | |
| 8-12 | 9.6728 | 0.5639 | 0.7272 | 1.1175 | 0.6251 | 12.8043 | 7.3604 | 0.6723 | 12.0146 | 7.3760 |
| micron | | | | | | | | | | |
| 12-16 | 13.7392 | 0.5126 | 0.6949 | 1.1161 | 0.6384 | 18.0626 | 10.7874 | 0.5870 | 17.7156 | 9.3968 |
| micron | | | | | | | | | | |
| 16-20 | 17.9029 | 0.5147 | 0.6973 | 1.1098 | 0.6526 | 23.0053 | 14.3284 | 0.5974 | 22.2835 | 12.2268 |
| micron | | | | | | | | | | |
| 20-24 | 22.0890 | 0.4530 | 0.6651 | 1.1098 | 0.6242 | 28.8601 | 17.3504 | 0.5311 | 28.8690 | 13.7848 |
| micron | | | | | | | | | | |
| 24-30 | 25.8914 | 0.3772 | 0.6464 | 1.1127 | 0.5712 | 34.8494 | 19.2014 | 0.4355 | 35.1756 | 14.7671 |
| micron | | | | | | | | | | |
| 30-45 | 34.3820 | 0.1588 | 0.5224 | 1.1666 | 0.4914 | 48.7370 | 24.9390 | 0.2770 | 55.4776 | 15.0294 |
| micron | | | | | | | | | | |

TABLE 6
Example of basaltic hyaloclastite ground in a ball mill to a volume-based mean particle size of
12 micron processed using a grinding aid with the particle properties in subranges as shown

| Particle | | | | | | | | Geodesic | | |
|---|---|---|---|---|---|---|---|---|---|---|
| Size | Diameter | Circle | Circu- | Rough- | Aspect | | | Aspect | Geodesic | Geodesic |
| Range | (Mean) | Fit | larity | ness | Ratio | Length | Width | Ratio | Length | Thickness |
| 0.75-1 | 0.9458 | 0.7962 | 0.7565 | 1.4158 | 0.5728 | 1.3695 | 0.7180 | 0.6644 | 1.9346 | 1.0423 |
| micron | | | | | | | | | | |
| 1-2 | 1.4084 | 0.8472 | 0.8857 | 1.2976 | 0.7791 | 1.8921 | 1.2050 | 0.8566 | 2.3967 | 1.8286 |
| micron | | | | | | | | | | |
| 2-4 | 2.8511 | 0.8395 | 0.8831 | 1.1983 | 0.8169 | 3.5841 | 2.4185 | 0.9091 | 3.7334 | 3.2297 |
| micron | | | | | | | | | | |
| 4-8 | 5.2513 | 0.7306 | 0.8217 | 1.1440 | 0.7088 | 6.7316 | 4.1445 | 0.8746 | 6.1733 | 5.0337 |
| micron | | | | | | | | | | |
| 8-12 | 9.6493 | 0.5824 | 0.7363 | 1.1173 | 0.6407 | 12.6106 | 7.4548 | 0.6952 | 11.7586 | 7.5240 |
| micron | | | | | | | | | | |
| 12-16 | 13.7804 | 0.4953 | 0.6898 | 1.1128 | 0.6210 | 18.2419 | 10.5182 | 0.5859 | 17.6686 | 9.4393 |
| micron | | | | | | | | | | |
| 16-20 | 17.7789 | 0.4403 | 0.6648 | 1.1158 | 0.5966 | 23.7021 | 13.6025 | 0.5086 | 23.7364 | 11.0869 |
| micron | | | | | | | | | | |
| 20-24 | 21.9769 | 0.4231 | 0.6616 | 1.1084 | 0.5907 | 29.6143 | 16.7095 | 0.5230 | 28.8777 | 13.6419 |
| micron | | | | | | | | | | |
| 24-30 | 27.0458 | 0.4494 | 0.6723 | 1.1099 | 0.6234 | 35.2943 | 21.3722 | 0.4995 | 34.8801 | 16.6386 |
| micron | | | | | | | | | | |
| 30-45 | 33.7842 | 0.3949 | 0.6320 | 1.1202 | 0.6388 | 43.1678 | 27.1938 | 0.4468 | 46.3779 | 18.9060 |
| micron | | | | | | | | | | |
| 45-60 | 53.244 | 0 | 0.428 | 1.077 | 0.27 | 98.615 | 29.829 | 0.194 | 101.021 | 19.646 |
| micron | | | | | | | | | | |

TABLE 7
Example of basaltic hyaloclastite ground in a roller plate Raymond mill to a volume-based mean
particle size of 12 micron processed using with the particle properties in subranges as shown

| Particle | | | | | | | | Geodesic | | |
|---|---|---|---|---|---|---|---|---|---|---|
| Size | Diameter | Circle | Circu- | Rough- | Aspect | | | Aspect | Geodesic | Geodesic |
| Range | (Mean) | Fit | larity | ness | Ratio | Length | Width | Ratio | Length | Thickness |
| 0.5-1 | 0.9465 | 0.8053 | 0.7742 | 1.4191 | 0.5990 | 1.3529 | 0.7359 | 0.6985 | 1.8866 | 1.0745 |
| micron | | | | | | | | | | |
| 1-2 | 1.3918 | 0.8486 | 0.8871 | 1.3016 | 0.7825 | 1.8626 | 1.1951 | 0.8601 | 2.3661 | 1.8160 |
| micron | | | | | | | | | | |
| 2-4 | 2.8200 | 0.8364 | 0.8788 | 1.2009 | 0.8134 | 3.5654 | 2.3802 | 0.9066 | 3.7273 | 3.2016 |
| micron | | | | | | | | | | |
| 4-8 | 5.3528 | 0.7212 | 0.8185 | 1.1411 | 0.6969 | 6.9145 | 4.1824 | 0.8646 | 6.2869 | 5.0900 |
| micron | | | | | | | | | | |
| 8-12 | 9.7403 | 0.5574 | 0.7246 | 1.1157 | 0.6172 | 12.9375 | 7.3445 | 0.6614 | 12.1312 | 7.3805 |
| micron | | | | | | | | | | |
| 12-16 | 13.9108 | 0.5171 | 0.7076 | 1.1074 | 0.6312 | 18.2211 | 10.8152 | 0.6160 | 17.2940 | 9.8087 |
| micron | | | | | | | | | | |
| 16-20 | 17.9486 | 0.5152 | 0.7082 | 1.1015 | 0.6583 | 23.1138 | 14.3247 | 0.6107 | 21.8564 | 12.4590 |
| micron | | | | | | | | | | |
| 20-24 | 21.8091 | 0.4861 | 0.6985 | 1.1059 | 0.6424 | 28.0565 | 17.0610 | 0.5794 | 26.9768 | 14.5405 |
| micron | | | | | | | | | | |
| 24-30 | 26.4975 | 0.4981 | 0.7038 | 1.1015 | 0.6738 | 33.4731 | 21.5399 | 0.5963 | 32.0156 | 17.7562 |
| micron | | | | | | | | | | |
| 30-45 | 33.1187 | 0.4107 | 0.6270 | 1.1390 | 0.6493 | 42.4405 | 26.8577 | 0.4293 | 46.6652 | 18.3740 |
| micron | | | | | | | | | | |
| 45-65 | 56.3398 | 0.0155 | 0.3930 | 1.1990 | 0.3010 | 91.9320 | 32.2740 | 0.2000 | 112.7040 | 17.4760 |
| micron | | | | | | | | | | |

Table 8 below shows examples of hyaloclastites, or lave quenched by water, that contain various amounts of amorphous and crystalline content. Samples 14 and 15 are rhyolitic glass such as perlite and the CaO content is below 1% compared with the basaltic in Samples 1-13 where CaO ranges between 9-16%.

TABLE 8

| | | Clinopyroxene | | | | |
|---|---|---|---|---|---|---|
| | | Ca(Mg,Fe,Al,Ti) | Plagioclase Feldspar | Olivine | | |
| | “Amorphous” | (Si,Al)2O6 | (Na,Ca)Al(Si,Al)3O8 | (Fe,Mg)2SiO4 | Calcite | Unidentified |
| 1 | >70 | — | 12 | 5 | 7 | <5 |
| 2 | >80 | | 10 | <5 | — | <5 |
| 3 | >70 | <3? | 11 | <5 | — | <5 |
| 4 | >80 | — | 13 | <3 | — | <5 |
| 5 | >55 | | 12 | 5 | 20 | <5 |
| 6 | >70 | — | 11 | 5 | <5 | <5 |
| 7 | >75 | — | 10 | 5 | — | <5 |
| 8 | >65 | — | 15 | 5 | <5 | <5 |
| 9 | >70 | <3? | 12 | 5 | | <5 |
| 10 | >30 | 25 | 43 | 5 | | <5 |
| 11 | >55 | | 15 | 5 | 15 | <5 |
| 12 | >40 | 17 | 37 | 4 | 1 | <5 |
| 13 | >70 | — | 15 | 8 | | <5 |
| 14 | >95 | | | | | <5 |
| 15 | >95 | | | | | <5 |

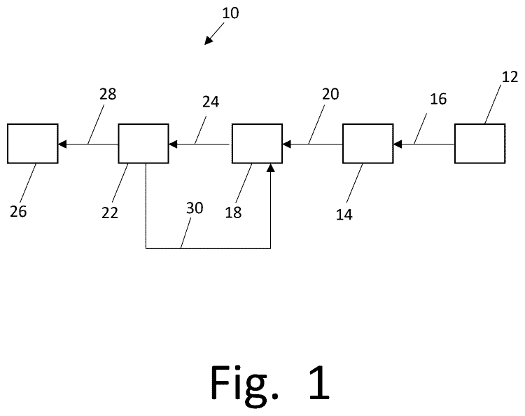

Referring now to FIG. 1, there is shown a flow diagram of a disclosed embodiment of a natural mineral filler processing plant 10 in accordance with the present invention. A natural volcanic mineral, such as lava quenched by water or hyaloclastite, is mined from the ground at a mine site. Unprocessed volcanic mineral may have a particle size of about 1/32 to ½ an inch or in the range a very fine sand to gravel. It may also have a larger size of lava pillows or breccia. The volcanic mineral is transported from the mine site to the natural mineral plant filler processing plant 10 where it is deposited in a supply pile 12. The volcanic mineral in the supply pile 12 may a moisture content of approximately 2 to 20% by weight. The volcanic mineral of particle sizes larger than sand may be reduced in size down to a 1/32 to ¼″ size by using a rock crusher. However, in order to reduce the particle size of the unprocessed volcanic mineral to the micron range by a dry process mill, it must have a moisture content of approximately 2% by weight or lower. Therefore, it is necessary to dry the unprocessed volcanic mineral. Accordingly, unprocessed volcanic mineral from the supply pile 12 is transported from the pile to a dryer 14 by a conveyor belt 16. The dryer 14 is typically a rotating drum or fluid bed (not shown) with a gas flame that projects into the drum or fluid bed or by an electric heating element. Helical flights or conveyer belts within the drum or fluid bed dryer move the hyaloclastite from the inlet of the drum or fluid bed to the outlet. The temperature inside the dryer is sufficiently high to allow for the desired reduction in moisture based on the moisture content of the materials fed into the dyer. From the dryer 14, the dried lava quenched by water or hyaloclastite, is transported to a micronizing mill 18 by either a conveyor belt or a screw conveyor 20. The mill 20 reduces the particle size of the lava or hyaloclastite from about the 1/32-½ inch size as it is mined from the ground, or pre-crushed by a rock crusher, to a desired particle size in the micron range. The micronizing mill can be a ball mil, a roller mill, a rod mill or any other type mill that can reduce a mineral down to the desired particle size. If a high aspect ratio particle size is desired, a vertical roller mill or a rod mill is a more desirable type mill to employ for the production of the natural mineral polymer filler. The micronizing mill can be a dry process mill circuit as described above or it can be a wet process mill circuit. From the mill 18, the reduced size lava quenched by water or hyaloclastite is lifted by the air flow into a particle size classifier 22 connected by a duct or pipe 24. The classifier separates particles that meet a desired size criteria from those that do not meet the criteria. Those particles that meet the size criteria are passed from the classifier 22 to a storage silo 26 by air flow or a screw conveyor 28. Those particles that are bigger than the size criteria are transported from the classifier 22 back to the input of the micronizing mill 18 by a retuning duct or pipe 30. The storage silo 26 is used to contain the lava quenched by water or hyaloclastite natural mineral polymer filler of the desires particle size range until it can be transported, such as by rail or truck, to a customer.

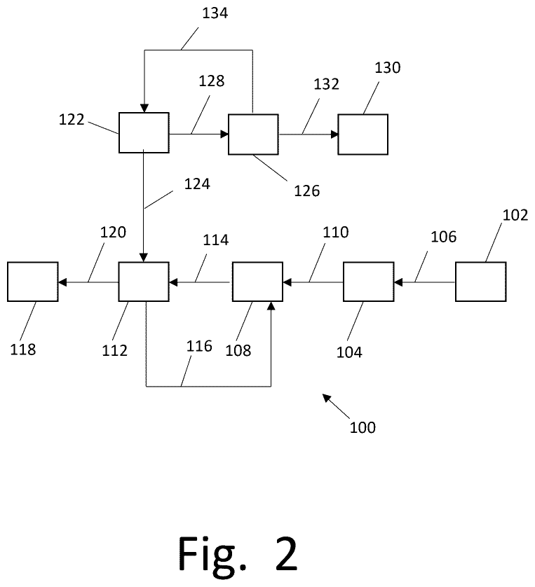

The foregoing process can be modified to include a two-mill grinding process (which would be within the ability of those skilled in the art). Referring now to FIG. 2, there is shown a flow diagram of another disclosed embodiment of a natural mineral filler two-stage processing plant 100 in accordance with the present invention. A natural volcanic mineral, such as hyaloclastite, or lava quenched by water, is mined from the ground at a mine site. The volcanic mineral is transported from the mine site to the natural mineral processing plant 100 where it is deposited in a supply pile 102. The volcanic mineral in the supply pile 102 may have a moisture content of approximately 2 to 20% by weight. The volcanic mineral of particle sizes larger than sand may be reduced in size down to a 1/32 to ¼ inch by using a rock crusher (not shown). However, in order to reduce the particle size of the unprocessed volcanic mineral to the micron range by a dry process mill, it must have a moisture content of approximately 2% by weight or lower. Certain types of mills such a vertical roller mills may have a built in dryer or if the mineral feed moisture contents is relatively low a drier may be optional. Accordingly, unprocessed volcanic mineral from the supply pile 102 is transported from the pile to a dryer 104 by a conveyor belt 106. The dryer 104 is typically a rotating drum or fluid bed (not shown) with a gas flame that projects into the drum or fluid bed or by an electric heating element. Helical flights or conveyer belts within the drum or fluid bed dryer move the hyaloclastite from the inlet of the drum or fluid bed to the outlet. The temperature inside the dryer is sufficiently high to allow for the desired reduction in moisture based on the moisture content of the materials fed into the dyer. From the dryer 104, the dried hyaloclastite, or lava quenched by water, is transported to a HPGR, roller plate mill or rod mill 108 by either a conveyor belt or a screw conveyor 110. The mill 108 fractures the particles of hyaloclastite, or lava quenched by water, from about 1/32 to about ½ inch size as it is mined from the ground, or pre-crushed by a rock crusher, into more elongated angular shaped particles a desired particle size in the micron range, such as a volume-based mean particle size of about 40 to about 150 μm. If a high aspect ratio particle size is desired, a vertical roller mill or a rod mill is a more desirable type mill 108 to employ for the production of the natural mineral polymer filler.

In an alternative disclosed embodiment of the present invention, depending on the amount of moisture in the hyaloclastite, or lava quenched by water, supply pile 102 the dryer 104 can be eliminated from the processing plant 100. A substantial amount of heat is produced by the fracturing process in the mill 108. This heat combined with the air flow through the mill 108 can be sufficient to dry the hyaloclastite, or lava quenched by water, during the fracturing process. Such would be highly advantageous as the drying process requires a substantial amount of energy, typically from fossil fuels.

From the mill 108, the reduced size hyaloclastite, or lava quenched by water, is lifted by the air flow into a particle size classifier 112 connected by a duct or pipe 114. The classifier separates particles that meet a desired size criteria from those that do not meet the criteria. Those particles that do not meet the desired criteria; i.e., are bigger than the size criteria, are transported from the classifier 112 back to the input of the mill 108 by a retuning duct or pipe 116. Those particles that meet the desired size criteria are passed from the classifier 112 to one of two locations. If the size and shape of the particles emerging from the classifier 112 are desired for the final product, the processed hyaloclastite, or lava quenched by water, are transported from the classifier 112 to a storage silo 118 by a conveyor or a screw auger 120. The storage silo 26 is used to contain the processed hyaloclastite, or lava quenched by water, natural rubber or polymeric rubber filler of the desires particle size range until it can be transported, such as by rail or truck, to a customer.

Depending on the size and shape of the hyaloclastite, or lava quenched by water, desired for the final product, the hyaloclastite, or lava quenched by water, from the mill 112 can be transported to a micronizing mill 122, such as a ball mill, jet mill or impact mill, both to reduce the particle size or to change the particle shape to a lower aspect ratio, to a more rounded or blocky shape, by a conveyor or a screw auger 124. Whether the processed hyaloclastite, or lava quenched by water, from the mill 112 is fed to the conveyor or auger 120 or 124 is controlled by a shunt (not shown). But, the processed hyaloclastite, or lava quenched by water, from the mill 112 can selectively be fed to either the conveyor or auger 120 or the conveyor or auger 124, or both.

The micronizing mill 122 can be a dry process mill circuit as described above or it can be a wet process mill circuit. It is preferred that the particles of hyaloclastite, or lava quenched by water, processed in the mill 122 have a volume-based mean particle size of about 0.1 to less than 40 μm, more preferably about 0.1 to about 20 μm, most preferably about 0.1 to about 10 μm.

From the mill 122, the reduced size hyaloclastite, or lava quenched by water, is lifted by the air flow into a second particle size classifier 126 connected by a duct or pipe 128. The classifier separates particles that meet a desired size criteria from those that do not meet the criteria. Those particles that meet the size criteria are passed from the second classifier 126 to a second storage silo 130 by air flow or a screw conveyor 132. Those particles that are bigger than the size criteria are transported from the second classifier 126 back to the input of the micronizing mill 124 by a retuning duct or pipe 134. The storage silo 130 is used to contain the hyaloclastite, or lava quenched by water, natural rubber or polymeric rubber filler of the desires particle size range until it can be transported, such as by rail or truck, to a customer.

In a disclosed embodiment, the present invention is a natural mineral filler for polymers comprising lava quenched by water or hyaloclastite with a chemical composition preferably comprising approximately 40 to approximately 69 percent by weight SiO₂, approximately 10 to approximately 18 percent by weight Al₂O₃, 4 to approximately 20 percent by weight CaO, and optionally one or more of approximately 3 to approximately 15% MgO and approximately 4 to approximately 18 percent by weight Fe₂O₃, ground into powder form. The particle size of the natural mineral filler powder is sufficiently small such that the lava quenched by water or hyaloclastite powder has polymer filler properties. The natural mineral polymer filler particle size in dry powder form preferably has a volume-based mean particle size of less than or equal to approximately 160 μm, or less than or equal to approximately 150 μm, or less than or equal to approximately 140 μm, or less than or equal to approximately 120 μm, or less than or equal to approximately 100 μm, or less than or equal to approximately 80 μm, or less than or equal to approximately 60 μm, or less than or equal to approximately 40 μm, or preferably less than or equal to approximately 20 μm, more preferably less than or equal to approximately 16 am, most preferably less than or equal to approximately 12 μm, especially less than or equal to approximately 10 μm, more especially less than or equal to approximately 8 μm, more especially less than or equal to approximately 4 μm and most especially less than or equal to approximately 2 μm. The foregoing ranges include all of the intermediate values. Different applications may require different particle sizes depending on the type of desired properties to be achieved. However, there are economic limits for grinding rock to small particle sizes. Those limits are well known by those skilled in the art. The natural mineral polymer filler particle size in dry powder form preferably has a Blaine value of approximately 1000 to approximately 12,000, preferably approximately 1,500 to approximately 10,000, more preferably approximately 3,500 to approximately 10,000, most preferably approximately 4,500 to approximately 10,000, especially approximately 6,000 to approximately 10,000. The foregoing ranges include all of the intermediate values. The natural mineral polymer filler particle size in either dry powder or wet solution, preferably has a Blaine value of greater than or equal to approximately 10,000. As the natural mineral polymer filler particle size in either dry powder or wet solution, is ground to the desired particle size, such as in the micronizing mill 18, a suitable grinding aid can be used. The finished natural mineral polymer filler particle size in either dry powder, that is collected from the particle size classifier 22 can be transported to the storage silo 26 using an enclosed or sealed screw conveyor 28 of a desirable diameter and length.

To achieve the desired particles size, lava quenched by water or hyaloclastite mineral can be ground using conventional mineral grinding equipment including, but not limited to, a ball mill, a roll mill or a plate mill. A particle size classifier can be used in conjunction with the mill to achieve the desired particle size. Equipment for grinding and classifying hyaloclastite to the desired particle size is commercially available from, for example, F. L. Smidth, Bethlehem, PA; Metso, Helsinki, Finland and others.

The ground hyaloclastite, or lava quenched by water, is then preferably classified by screening the powder with a 100-mesh screen or sieve. Preferably, approximately 60% by volume of hyaloclastite, or lava quenched by water, mineral powder passes through a 100-mesh screen, more especially approximately 80% by volume of hyaloclastite, or lava quenched by water, mineral powder passes through a 100-mesh screen more especially approximately 90% by volume hyaloclastite, or lava quenched by water, mineral powder passes through a 100-mesh screen, especially approximately 95% by volume hyaloclastite, or lava quenched by water, mineral powder passes through a 100-mesh screen and more especially approximately 100% by volume hyaloclastite, or lava quenched by water, powder passes through a 100-mesh screen. Preferably approximately 60% to approximately 100% by volume hyaloclastite, or lava quenched by water, powder passes through a 100-mesh screen, preferably approximately 80% to approximately 100% by volume hyaloclastite, or lava quenched by water, powder passes through a 100-mesh screen, preferably approximately 90% to approximately 100% by volume hyaloclastite, or lava quenched by water, powder passes through a 100-mesh screen, most preferably approximately 95% to approximately 100% by volume hyaloclastite, or lava quenched by water, mineral powder passes through a 100-mesh screen, especially approximately 100% by volume hyaloclastite, or lava quenched by water, mineral powder passes through a 100-mesh screen. In another embodiment the ground hyaloclastite, or lava quenched by water, is then preferably classified by screening the powder with a 200-mesh screen or sieve. Preferably approximately 90% by volume hyaloclastite, or lava quenched by water, mineral powder passes through a 200-mesh screen, especially approximately 95% by volume hyaloclastite, or lava quenched by water, mineral powder passes through a 200-mesh screen and more especially approximately 200% by volume hyaloclastite, or lava quenched by water, powder passes through a 200-mesh screen. Preferably approximately 90% to approximately 100% by volume hyaloclastite, or lava quenched by water, powder passes through a 200-mesh screen, most preferably approximately 95% to approximately 100% by volume hyaloclastite, or lava quenched by water, mineral powder passes through a 200-mesh screen, especially approximately 100% by volume hyaloclastite, or lava quenched by water, mineral powder passes through a 200-mesh screen. In yet another embodiment the ground hyaloclastite, or lava quenched by water, is then preferably classified by screening the powder with a 300-mesh screen or sieve. Preferably approximately 90% by volume hyaloclastite, or lava quenched by water, mineral powder passes through a 300-mesh screen, especially approximately 95% by volume hyaloclastite, or lava quenched by water, mineral powder passes through a 300-mesh screen and more especially approximately 100% by volume hyaloclastite, or lava quenched by water, powder passes through a 300-mesh screen. Preferably approximately 90% to approximately 100% by volume hyaloclastite, or lava quenched by water, powder passes through a 300-mesh screen, most preferably approximately 95% to approximately 100% by volume hyaloclastite, or lava quenched by water, mineral powder passes through a 300-mesh screen, especially approximately 100% by volume hyaloclastite, or lava quenched by water, mineral powder passes through a 300-mesh screen.

In one disclosed embodiment of the present invention, hyaloclastite, or lava quenched by water, preferably has a chemical composition of approximately 40% to approximately 65% by weight SiO₂, approximately 10% to approximately 18% by weight Al₂O₃, 4% to approximately 20% by weight CaO, approximately 3% to approximately 15% by weight MgO, approximately 4% to approximately 18% by weight Fe₂O₃. In addition to the foregoing, other compounds can be present in small amounts, such as K₂O, TiO₂, P₂O₅, MnO, various metals, rare earth trace elements and other unidentified elements. When combined, these other compounds represent less than 10% by weight of the total chemical composition of the lava quenched by water or hyaloclastite mineral.

In another disclosed embodiment, the lava quenched by water or hyaloclastite mineral filler in accordance with the present invention preferably has a density or specific gravity of approximately 2.6 to approximately 3.1.

In another disclosed embodiment, the hyaloclastite, or lava quenched by water, mineral filler in accordance with the present invention preferably has a hardness on the Mohs scale of 5.5-8, preferably 6-7.5, more preferably 6.5-7.5. The foregoing ranges include all intermediate values.

Hyaloclastite, or lava quenched by water, in accordance with the present invention can be in crystalline or amorphous (glassy) form and is usually found as a combination of both in varying proportions. Preferably, hyaloclastite, or lava quenched by water, in accordance with the present invention comprises approximately 0% to 100% by weight amorphous form, more preferably approximately 10% to approximately 80% by weight amorphous form, most preferably approximately 20% to approximately 60% by weight amorphous form, especially approximately 30% to approximately 50% by weight amorphous form. The crystalline portion of hyaloclastite, or lava quenched by water, preferably comprises approximately 3% to approximately 20% by weight olivine, approximately 5% to approximately 40% by weight clinopyroxene, approximately 5% to approximately 60% by weight plagioclase, and approximately 0% to approximately 40% (or less than 40%) by weight other minerals including, but not limited to, magnetite, UlvoSpinel, quartz, feldspar, pyrite, illite, hematite, chlorite, calcite, hornblende, biotite, K-feldspars, mordenite, clinoamphibole, ilmenite hypersthene (an orthopyroxene), feldspathoids sulfides, metals, rare earth minerals, other unidentified minerals and combinations thereof. The foregoing ranges include all of the intermediate values.

Hyaloclastite, or lava quenched by water, filler in accordance with the present invention preferably can be added to polymeric materials in amounts of approximately 0.1% to approximately 95% by weight, more preferably approximately 0.1% to approximately 50% by weight, most preferably approximately 0.1% to approximately 25% by weight, especially approximately 0.1% to approximately 10% by weight, more especially approximately 0.1% to approximately 5% by weight, depending on the application and particle size of the filler needed to achieve the desired properties. Furthermore, the amount of hyaloclastite, or lava quenched by water, in accordance with the present invention that can be added to polymers depends on the viscosity needed for a particular polymer application. Generally speaking, the greater the amount of filler added and the smaller the particle size of the filler added, the lower the viscosity of the polymeric composition. The foregoing ranges are applicable to the addition of hyaloclastite, or lava quenched by water, to all polymeric materials including, but not limited to, solid polymeric materials, rigid or flexible foamed polymeric materials and polymeric coatings, such as paints or other protective coatings.

Polyurethane compositions are well known in the art. Polyurethane compositions can be solid or cellular, flexible or rigid. Polyurethane compositions in accordance with the present invention may be solid or cellular, i.e., foamed or frothed, rigid or flexible. The particular composition of the polyurethane-forming components is not a critical aspect of the present invention. Solid polyurethane compositions are used for many applications, such as structural members and textile coatings, such as carpet backing coatings to adhere tufts to primary backing materials or to adhere secondary backing materials to primary backing materials. Cellular polyurethane, such as foamed or frothed polyurethane, is used for items such as insulation board, spray foam, cushions and textile coatings, such as integrally attached cushions for carpet. With all types of polyurethane compositions historically fillers have been selected from materials of low cost as means to reduce the overall cost of the finished product as to reduce the cost per unit volume of the polyurethane compositions. Fillers that have been known for use in polyurethane compositions include, clays, wood flour, cork, dust, cotton flock, shredded or finely powdered cornsilks, finely ground nut shells, fly ash, ground recycled glass and the like. While these fillers are used to replace polyurethane and therefore reduce cost, they do very little to improve physical, thermal, insulating value, flame spread and fire resistance properties of foam.

Hyaloclastite, or lava quenched by water, with a basaltic or intermediate-basaltic chemical compositions is an inert and thermally stable natural mineral with high mechanical and thermal resistance. Polymeric materials using a mineral filler in powder form made from hyaloclastite or lava quenched by water in accordance with the present invention have enhanced properties such as improved friability, rigidity, hardness, fire resistance, flame spread and thermal properties. Physical properties such as compressive, flexural and tensile strength are improved by the use of fillers in accordance with the present invention in polyurethane foams or rigid products. Hyaloclastite, or lava quenched by water, mineral filler in accordance with the present invention contributes to the decrease of the heat release rate, thereby showing improved thermal stability, flame spread and fire resistance of the polymeric materials using this type mineral filler. Polymeric foams using the hyaloclastite mineral filler show self-extinguishing properties.

Polyurethane is a polymerization product of a polyol component, an isocyanate component, water (optional) and a catalyst system that promotes a polymerization reaction between the isocyanate component and the polyol component to form the polyurethane. Conventional practice in the art is to form an isocyanate mixture, referred to as SIDE A; and to form a mixture of polyols, chain extenders, crosslinking agents, fillers, blowing agents, surfactants, catalysts etc., commonly referred to as SIDE B. The SIDE A component and the SIDE B component are mixed together at a desired ratio to form the polyurethane polymer.

The polyol component may contain either a single polyol or a mixture of two or more polyols. The specific polyols useful in the manufacture of polyurethane elastomers are well known in the art and include aliphatic, alicyclic and aromatic polyols. More specifically, the polyol component useful in this invention has an average functionality within the range of 2-8, preferably within the range of 2-3, and an average molecular weight of from about 900 to about 9000, preferably from about 1000 to about 6000. The polyol component may contain isomeric and polymeric polyols. Additionally, the polyol component has a hydroxyl number of less than about 150, preferably less than about 115.

The preferred polyols suitable for use in the present invention include, but are not limited to, ethylene glycol; diethylene glycol; propylene glycol; dipropylene glycol; glycerine; sucrose; butylene glycol; polyether polyols derived from ethylene oxide, propylene oxide, and mixtures of such oxides; polyether polyols derived from propylene oxide and capped with ethylene oxide; polyethylene glycol; polypropylene glycol; polybutylene glycol; 1,2-polydimethylene glycol; polydecamethylene glycol and combinations and mixtures of the above polyols.

The polyurethane composition can be either foamed or unfoamed. In those instances where foaming is desired, such can be accomplished by using an inert gas frothing technique, a volatile liquid blowing agent technique, a chemically blown (water) technique or combinations thereof, in conjunction with a surface-active agent, such as the commercially available block polysiloxanepolyoxyalkylene copolymers. Chemical blowing of the polyurethane composition, if desired, is affected by controlling the catalyst system, the water concentration and the isocyanate level. Generally, water is present in the reaction mixture from between approximately 0.01 to 5.0 parts per hundred parts of polyol, preferably between 0.1 parts and 2 parts, over and above the water normally present in the reaction mixture. The catalyst system not only must affect rapid curing but also must control formation of carbon dioxide resulting from the reaction of water and isocyanate. Blowing should be controlled to affect expansion preferably between about 5% and 200%, more preferably between approximately 7% and 100%, depending on the application. Suitable catalysts are those which promote polyurethane formation and concurrently promote the blowing reaction. Preferred catalysts are organic metal compounds, amines, and metal soaps, such catalysts include dibutyl tin dilaurate and stannous octanoate.

The isocyanate component may contain either a single isocyanate or a mixture of two or more isocyanates. The specific isocyanates useful in the manufacture of polyurethane polymers are well known in the art and include aliphatic, alicyclic and aromatic isocyanates. Preferred isocyanates have an average functionality within the range of 2-8, preferably within the range of 2-5. Examples of preferred isocyanates are 2,4-toluene diisocyanate; 2,6-toluene diisocyanate; 1,6-hexamethylene diisocyanate; naphthalene-1,4-diisocyanate; diphenyl methane 4,4′diisocyanate;
4,4′-diphenylene diisocyanate; 3,3′-dimethoxy biphenylene diisocyanate; polymeric forms of the above diisocyanates, diisocyanato carbodiimide modified diphenylmethane 4,4′-diisocyanate (MDI), isocyanate terminated prepolymers, and mixtures of the foregoing. The isocyanate component (Side A) usually is employed in stoichiometric excess to assure complete reaction with the functional groups of the polyol and with any water which may be present. Preferably, from 20 to 80 parts isocyanate per one hundred parts of polyol are used in the reaction mixture.

A general polyurethane formulation that is useful in the present invention is shown in Table 9 below:

TABLE 9

| Ingredient | Parts |
|---|---|
| Polyol A (triol) | 100 |
| Polyol B (diol) | |
| Polyol C (Chain extender) | |
| Surfactant (silicon glycol | 0-2 |
| copolymer) | |
| Water | 0-2 |
| Hyaloclastite filler | 0-400 |
| Additives | 0-50 |
| Catalysts | 0.002-3 |
| Isocyanate | sufficient |
| | (index 70-130) |

In order to prepare a mineral filled polyurethane formulation, hyaloclastite mineral filler in accordance with present invention is added to the polyurethane-forming components. The hyaloclastite mineral filler can be added in amounts between approximately 5% and 95% by weight. The polyurethane compositions of the present invention can be used to make polyurethane foams having densities of from approximately 7 to 80 pounds per cubic foot.

The hyaloclastite mineral filler can be made of ground lava quenched by water of any chemistry in the range of the basaltic to intermediate-basaltic or andesitic. Irrespective of the chemical composition of the lava, the hyaloclastite mineral filler useful in the present invention should have a pH in deionized water of not greater than 8.4. Preferably, the hyaloclastite mineral filler can be made of lava quenched by water of any chemistry in the range of the basaltic to intermediate-basaltic or andesitic useful in the present invention should have a pH in deionized water of about 7 to 8.4.

The average size of the particles of the hyaloclastite mineral filler can be made of lava quenched by water of any chemistry in the range of the basaltic to intermediate-basaltic or andesitic is a critical element of the present invention. In determining the particle size of the hyaloclastite mineral filler can be made of lava quenched by water of any chemistry in the range of the basaltic to intermediate-basaltic useful in the present invention, three factors must be balanced: reaction rate, viscosity and stability. The smaller the particle size of the hyaloclastite mineral filler, the greater the catalytic effect of the hyaloclastite mineral filler, and, therefore, the faster the polyurethane forming reaction will occur. On the other hand, the smaller the hyaloclastite mineral filler particle size, the higher the viscosity of the Side B composition. Furthermore, the smaller the particle size, the more stable the polyurethane composition; i.e., the hyaloclastite mineral filler will remain in suspension in the Side B composition. The hyaloclastite mineral filler useful in the present invention should have an average particle size such that the Side B composition has a viscosity of approximately 1,000 to 13,000 cps at 25° C. Stated another way, the hyaloclastite mineral filler useful in the present invention should have an average particle size not greater than about 150 microns and not less than about 4 microns. Preferably, the hyaloclastite useful in the present invention should have a volume-based mean particle size is preferably not greater than about 100 microns and not less than about 40 microns. Depending on the application, the hyaloclastite may have a smaller particle size, such as less than or equal to 40 microns, preferably less than or equal to 20 microns, especially less than or equal to 10 μmicros.

In accordance with the present invention, the hyaloclastite powder is combined or mixed with the polymeric material so as to provide a uniform mixture. The hyaloclastite powder can be combined or mixed with the uncured or unset polymeric material (i.e., liquid polymeric material) using equipment well known in the art for performing such processing. In the case of thermoplastic polymers, the hyaloclastite can also be combined with solid thermoplastic polymer material (e.g., pellets) prior to extrusion. The hyaloclastite powder and thermoplastic polymer material can then be extrude together thereby mixing those two components during the extrusion process. There are many other ways know to those skilled in the art for mixing a polymer additive or filled thereto and all such processes and equipment are contemplated by the present invention.

The following examples are illustrative of the present invention and are not intended to limit the scope of the invention as set forth in the appended claims. All temperatures are in degrees Fahrenheit and all percentages are by weight unless specifically stated otherwise.

### Example 1, 2 and 3

Examples of polyurethane formulations useful in the present invention are given in the Table 10 below:

TABLE 10

| Ingredient | Formula A | Formula B | Formula C |
|---|---|---|---|
| High (−6,000) molecular | 45 | 45 | 45 |
| weight triol | | | |
| High (−6,000) molecular | 45 | 45 | 45 |
| weight diol | | | |
| Low (−400) molecular | 10 | 10 | 10 |
| weight diol | | | |
| Surfactant | 2 | 2 | 2 |
| Calcium Carbonate | 65 | 0 | 35 |
| Hyaloclastite Filler | 35 | 100 | 65 |
| Tin Catalyst | 1 | 1 | 1 |
| Isocyanate 344kd | Sufficient | Sufficient | Sufficient |
| | (70-100) | (70-100) | (70-100) |

In order to be commercially useful, the polyurethane formulations in accordance with the present invention should have a reactivity of greater than 5 μminutes, should have a cure time of less than 130 seconds and should be stable for at least 14 days.

Generally, the polyurethane compositions of the present invention should have a viscosity of less than about 18,000 cps at 25° C.; preferably less than about 13,000 cps at 25° C.; and especially preferred approximately 3,000 to approximately 10,000 cps at 25° C.

### Example 4, 5 and 6

Additional examples of polyurethane formulations using a hyaloclastite filler in accordance with the present invention are given in the Table 11 below:

TABLE 11

| Ingredient | Formula A | Formula B | Formula C |
|---|---|---|---|
| High (−6,000) molecular | 50 | 50 | 50 |
| weight triol | | | |
| High (−6,000) molecular | 45 | 45 | 45 |
| weight diol | | | |
| Low (−400) molecular | 5 | 5 | 5 |
| weight diol | | | |
| Surfactant | 2 | 2 | 2 |
| Calcium Carbonate | 130 | 0 | 70 |
| Hyaloclastite Filler | 70 | 200 | 130 |
| Tin Catalyst | 1 | 1 | 1 |
| Isocyanate 344kd | Sufficient | Sufficient | Sufficient |
| | (70-100) | (70-100) | (70-100) |

Alternatively, polyurethane foam production can be performed by using formulated polyether polyol, diphenylmethane-4,4′-diisocyanate (MDI) (both from Bayer Material Science—PUR FERT), and hyaloclastite or lava quenched by water ground to a mean particle size of approximately 2 μm to approximately 100 μm. The polymerization reactions are performed using the “one-shot” process at 25° C. modified by adding the hyaloclastite mineral filler to the medium. First, 10.90 mg of polyol is introduced inside a glass batch reactor and mixed with a mechanical stirrer (for 40 s at 100 rpm) with different proportions such as 0, 20, 40, and 60 wt % of hyaloclastite mineral filler powder to the total weight and different hyaloclastite mineral filler particle size between 4 μm to 60 μm. Subsequently, 12.30 mg of MDI is added to the mixture, followed by stirring. The composite foams can be cured at room temperature, such as inside a mold, for 24 hrs or they can be cured in an accelerated way at higher temperatures. Upon curing various physical, thermal, fire resistance and flame spread properties are tested.

The polyurethane in accordance with the present invention can be used as insulating foam products such as in-situ spray foam applications or insulating foam boards. The manufacture of foam boards requires the use of facers. Facings for use in the present invention include any flat, sheet material suitable to the required end application of the final board product. At least the upper facer must be flexible enough to be wrapped tightly around a metering roll. Facers must also be flat enough to not significantly alter the small gap between metering rolls. Such materials include aluminum foil/kraft paper laminations, bare aluminum foil, paper roof insulation facings, and coated glass fiber mats. A facer, as used herein, may also include plywood, oriented strandboard or gypsum, in which case such rigid material is conveyed to the laminator, and foam-forming mixture is preferably applied directly thereon. Alternatively, panel facers can be made of metal sheets, such as steel or aluminum, to create a structural or non-structural insulated metal panel.

The polyurethane in accordance with the present invention can be used to make any other type of rigid polymeric plastic object such as open or closed cell mats, membranes, foams, components or the like.

Polyisocyanurate foam compositions are well known in the art. The composition comprises an isocyanate reactive compound, polyisocyanate, blowing agent and generally other optional additives such as surfactants and the like. In the past to certain mineral filler have been used such as a mica, talc and similar filler component. Mineral fillers previously used in foams were selected from a low-cost point of view as means to replace more expansive polymeric materials. Thus, mineral fillers of the prior art have been used to reduce the overall finished product cost of the polymeric foams. In the present invention, the thermal and physical properties of the ground hyaloclastite or lava quenched by water used as mineral filler allows for great improvements in the thermal, flame spread, fire resistance and physical properties of the polyisocyanurate foams. The hyaloclastite or lave quenched by water mineral filler is loaded from about 0.5 to about 60 wt % based on the isocyanate reactive compound, preferably a polyol, and the average particle size of the filler ranges from about 2 μm to about 60 km.

The foam material prepared in accordance with the present invention can contain a high loading of filler, yet still exhibits excellent foam properties rate foam, or at least the general negative effects caused by a filler are minimized, such as friability at high loading levels of the filler. In the broadest aspects of the present invention, any organic polyisocyanate can be employed in the preparation of the rigid polyisocyanurate foams. The organic polyisocyanates that can be used include aromatic, aliphatic and cycloaliphatic polyisocyanates and combinations thereof. Representative of the polyisocyanates are the diisocyanates, such as m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, diphenyl methane-4,4′-diisocyanate, 4,4′-dipheny lenediisocyanate, 3,3′-dimethoxy-4,4′-biphenyldiisocyanate, 3,3′-dimethy Idiphenylmethane-4,4′-diisocyanate; the triisocyanates, such as 4,4′,4′-triphenylmethane-triisocyanate, polymethylenepolyphenyl isocyanate, toluene-2,4, 6-triisocyanate; and the tetraisocyanates, such as 4,4′dimethyldiphenylmethane-2,2′,5,5′-tetraisocyanate. Generally, suitable polyisocyanate includes aliphatic and aromatic polyisocyanates, such as poly(isocyanatophenylmethylene), phenylisocyanate, 2,4-toluenediisocyanate, 2,6-toluenediisocyanate, 2,4′-diphenylmethanediisocyanate, 4,4′diphenylmethanediisocyanate, hexamethylenediisocyanate, isophoronediisocyanate, 1,4-cyclohexanediisocyanate and the like. The type of polyisocyanate used is not a critical aspect of the present invention.

Prepolymers can also be employed in the preparation of the foams of the present invention. These prepolymers are prepared by reacting an excess of organic polyisocyanate or mixtures thereof with a minor amount of an active hydrogen-containing compound as determined by the well-known Zerewitinoff test, as described by Kohler in “Journal of the American Chemical Society,” 49, 3181 (1927). These compounds and their methods of preparation are well known in the art. The use of any one specific active hydrogen compound is not critical hereto, rather any such compound can be employed in the practice of the present invention. The type of prepolymer used is not a critical aspect of the present invention.

Preferred isocyanates used according to the present invention may include Mondur 489 (Bayer), Rubinate 1850 (ICI), Luprinate M70R (BASF) and Papi 580 (Dow). Isocyanate indices greater than about 200 are preferred, particularly from about 225 to about 325.

In addition to the polyisocyanate, the foam-forming formulation can also contain an organic compound containing isocyanate reactive groups, preferably at least 1.8 or more isocyanate-reactive groups per molecule. Preferred isocyanate-reactive compounds are the polyester and polyetherpolyols. These compounds could be derived from petroleum based raw materials or renewable resources such as soybean oil, castor oil, linseed oil, tall oil etc. (Journal of Polymers and the Environment, Vol. 12, No. 3, July 2004, Page 123).

The polyester polyols useful in the present invention can be prepared by known procedures from a polycarboxylic acid or acid derivative, such as an anhydride or ester of the polycarboxylic acid, and a polyhydric alcohol. The acids and/or the alcohols can be used as mixtures of two or more compounds in the preparation of the polyester polyols. The polycarboxylic acid component, which is preferably dibasic, may be aliphatic, cycloaliphatic, aromatic and/or heterocyclic and may optionally be substituted, for example, by halogen atoms, and/or can be unsaturated. Examples of suitable carboxylic acids and derivatives thereof for the preparation of the polyester polyols include: oxalic acid; malonic acid; succinic acid; glutaric acid; adipic acid; pimelic acid; suberic acid; azelaic acid; sebacic acid; phthalic acid; isophthalic acid; trimellitic acid; terephthalic acid; phthalic acid anhydride; tetrahydrophthalic acid anhydride; pyromellitic dianhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dibasic and tribasic unsaturated fatty acids optionally mixed with monobasic unsaturated fatty acids, such as oleic acid; terephthalic acid dimethyl ester and terephthalic acid-bis-glycol ester. Any suitable polyhydric alcohol can be used in preparing the polyester polyols. The polyols can be aliphatic, cycloaliphatic, aromatic and/or heterocyclic, and are preferably selected from the group consisting of diols, triols and tetrols. Aliphatic dihydric alcohols having no more than about 20 carbon atoms are highly satisfactory. The polyols optionally can include substituents which are inert in the reaction, for example, chlorine and bromine substituents, and/or can be unsaturated. Suitable amino alcohols, such as, for example, mono ethanolamine, diethanolamine, triethanolamine, or the like can also be used. Moreover, the polycarboxylic acid(s) can be condensed with a mixture of polyhydric alcohols and amino alcohols. The type of polyester polyol used is not a critical aspect of the present invention and other polyester polyols known in the art can be used.

Examples of suitable polyhydric alcohols include: ethylene glycol; propylene glycol-(1,2) and -(1,3); butylene glycol-(1,4) and -(2,3); hexane diol-(1,6); octane diol-(1,8); neopentyl glycol; 1,4-bishydroxymethyl cyclohexane; 2-methyl-1,3-propane diol; glycerin; trimethylolpropane; trimethylolethane; hexane triol-(1,2,6); butane triol-(1,2,4); pentaerythritol; quinitol; mannitol; sorbitol; formitol; a-methylglucoside; diethylene glycol; triethylene glycol tetraethylene glycol and higher polyethyleneglycols; dipropylene glycol and higher polypropylene glycols as well as dibutylene glycol andhigherpolybutylene glycols. Especially suitable polyols are oxyalkylene glycols, such as diethylene glycol, dipropylene glycol, triethylene glycol, tripropylene glycol, tetraethylene glycol, tetrapropylene glycol, trimethylene glycol and tetramethylene glycol. The type of polyhydric alcohols used is not a critical aspect of the present invention and other polyhydric alcohols known in the art can be used.

Particularly preferred polyester polyols can include Stepanpol PS2352 (Stepan) and Terate 2541 (Hoechst Celanese). Preferred amounts of the polyester polyols are consistent with isocyanate indices greater than 200, preferably about 225 to about 325.

Polyether polyols useful according to the present invention include the reaction products of a polyfunctional active hydrogen initiator and a monomeric unit such as ethylene oxide, propylene oxide, butylene oxide and mixtures thereof, preferably propylene oxide, ethylene oxide or mixed propylene oxide and ethylene oxide. The polyfunctional active hydrogen initiator preferably has a functionality of 2-8, and more preferably has a functionality of 3 or greater.

A wide variety of initiators can be alkoxylated to form useful polyether polyols. Thus, for example, poly-functional amines and alcohols of the following type can be alkoxylated: monoethanolamine, diethanolamine, triethanolamine, ethylene glycol, polyethylene glycol, propylene glycol, hexanetriol, polypropylene glycol, glycerine, sorbitol, trimethylolpropane, pentaerythritol, sucrose and other carbohydrates. Such amines or alcohols can be reacted with the alkylene oxide(s) using techniques known to those skilled in the art. The hydroxyl number which is desired for the finished polyol would determine the amount of alkylene oxide used to react with the initiator. The polyether polyol can be prepared by reacting the initiator with a single alkylene oxide, or with two or more alkylene oxides added sequentially to give a block polymer chain or at once to achieve a random distribution of such alkylene oxides. Polyol blends such as a mixture of high molecular weight polyether polyols with lower molecular weight poly ether polyols can also be employed. The type of initiators used is not a critical aspect of the present invention and other initiators known in the art can be used.

Any suitable blowing agent can be employed in the foam compositions of the present invention. In general, these blowing agents are liquids having a boiling point between minus 50° C. and plus 100° C. and preferably between 0° C. and 50° C. The preferred liquids are hydrocarbons or halohydrocarbons, such as chlorinated and fluorinated hydrocarbons. Suitable blowing agents include HCFC-141 b (1-chloro-1, 1-difluoroethane), HCFC-22 (monochlorodifluoromethane), HFC-245 fa (1,1,1,3,3-pentafluoropropane), HFC-134a (1,1,1,2-tetrafluoroethane), HFC-365mfc (1,1,1,3,3-pentafluorobutane), cyclopentane, normal pentane, isopentane, LBL-2 (2-chloropropane), trichlorofluoromethane, CCl2 FCCIF 2′ CCl, FCHF 2′ trifluorochloropropane, 1-fluoro-1, I-dichloroethane, 1,1, I-trifluoro-2,2-dichloroethane, methylene chloride, diethylether, isopropyl ether, methyl formate, carbon dioxide and combinations and mixtures thereof. The type of blowing agents used is not a critical aspect of the present invention and other blowing agent known in the art can be used.

The foaming agents generally comprise from 1 to 30, and preferably comprise from 5 to 20 weight percent of the composition. When a foaming agent has a boiling point at or below ambient, it is maintained under pressure until mixed with the other components. Alternatively, it can be maintained at sub-ambient temperatures until mixed with the other components. Mixtures of foaming agents can be employed.

Any suitable surfactant can be employed in the foams of this invention, including silicone/ethylene oxide/propylene oxide copolymers. Examples of surfactants useful in the present invention include, among others, polydimethylsiloxane-polyoxyalkylene block copolymers available from Witco Corporation under the trade names “L-5420”, “L-5340”, and Y10744; from Air Products under the trade name “DC-193”; from Goldschmidt under the name, Tegostab B84PI; and Dabco DC9141. Generally, the surfactant comprises from about 0.05 to 10, and preferably from 0.1 to 6, weight percent of the foam-forming composition. The type of surfactants used is not a critical aspect of the present invention and other surfactants known in the art can be used.

Additives include surfactants (silicon, phosphorus, fluorine and the like), catalysts (triethyl amine, benzyl dimethyl amine, triethylenediamine, potassium t-butoxide, sodium borohydride, hydroxides of quaternary nitrogen, sodium formate, sodium benzoate, potassium acetate, calcium diacetate, potassium octoate, N,N-dimethylethanol amine, N-ethylmorpholine, tetramethylbutane diaminecarboxilic salts of tin, zinc, lead, mercury, cadmium, bismuth, antimony, iron, manganese, cobalt, copper, vanadium, and the like), colorants, mold release agents, flame retardants, antioxidants and the like.

Facings for use in the present invention include any flat, sheet material suitable to the required end application of the final board product. At least the upper facer must be flexible enough to be wrapped tightly around a metering roll. Facers must also be flat enough to not significantly alter the small gap between metering rolls. Such materials include, but are not limited to, aluminum foil/kraft paper laminations, bare aluminum foil, paper roof insulation facings, and coated glass fiber mats. A facer, as used herein, may also include oriented strandboard or gypsum, in which case such rigid material is conveyed to the laminator, and foam-forming mixture is preferably applied directly thereon. Alternatively, panels facers can be made of metal sheets, such as steel or aluminum, to create a structural or non-structural insulated metal panel. The type of facing used is not a critical aspect of the present invention and other facings known in the art can be used.

The filler used in the present polyisocyanurate foam composition is ground hyaloclastite, or lava quenched by water, of basaltic or intermediate-basaltic chemical composition in powder form. The ground hyaloclastite, or lava quenched by water, of basaltic or intermediate-basaltic chemical compositions in a powder form is present at high loading, preferably 0.5 to about 60% by weight based on the isocyanate reactive compounds, more preferably 1 to about 45 wt %, more preferably 2 to about 30 wt %, and more preferably about 3 to about 15 wt %, and most preferably about 5 to about 15 wt %. At such loadings, it is important that the ground hyaloclastite, or lava quenched by water, of basaltic or intermediate-basaltic chemical composition in powder form has a volume-based mean particle size of approximately 2 μm to approximately 60 μm, more preferably approximately 4 μm to approximately 40 μm, more preferably approximately 5 μm to approximately 30 μm, and more preferably approximately 6 μm to approximately 20 μm and most preferably approximately 7 μm to approximately 16 μm. The composition of the present invention provides a rigid polyisocyanurate foam material that also exhibits superior thermal stability, fire resistance, flame spread and physical properties.

In the laboratory experiment low density (−1.5-1.7) free rise foam cup is made at room temperature with an isocyanate index at 250. The hyaloclastite, or lava quenched by water, of basaltic or intermediate-basaltic chemical composition filler is mixed with the polyols along with the other ingredients. Then, it is mixed with MDI with stirring to make free rise foam. The foam is cured at room temperature for 24 h and then tested for various properties based on the following examples.

### Example 7

A low percentage (2 wt % in polyol) of hyaloclastite of basaltic chemical composition filler of 10 μm volume-based mean particle size is added to the polyisocyanurate foam ingredients mix with a ratio between the PIR/PUR of 2.31.

### Example 8

A low percentage (2 wt % in polyol) of hyaloclastite of basaltic chemical compositions filler of 20 μm volume-based mean particle size is added to the polyisocyanurate foam ingredients mix with a ratio between the PIR/PUR of 2.31.

### Example 9

A low percentage (2 wt % in polyol) of hyaloclastite of basaltic chemical compositions filler of 30 μm volume-based mean particle size is added to the polyisocyanurate foam ingredients mix with a ratio between the PIR/PUR of 2.31

### Example 10

A low percentage (2 wt % in polyol) of hyaloclastite of basaltic chemical compositions filler of 40 μm volume-based mean particle size is added to the polyisocyanurate foam ingredients mix with a ratio between the PIR/PUR of 2.31

### Example 11

A higher percentage (10 wt % in polyol) of hyaloclastite of basaltic chemical compositions filler of 10 μm volume-based mean particle size is added to the polyisocyanurate foam ingredients mix with a ratio between the PIR/PUR of 2.29.

### Example 12

A higher percentage (10 wt % in polyol) of hyaloclastite of basaltic chemical compositions filler of 20 μm volume-based mean particle size is added to the polyisocyanurate foam ingredients mix with a ratio between the PIR/PUR of 2.38.

### Example 13

A higher percentage (10 wt % in polyol) of hyaloclastite of basaltic chemical compositions filler of 30 μm volume-based mean particle size is added to the polyisocyanurate foam ingredients mix with a ratio between the PIR/PUR of 2.42

### Example 14

A higher percentage (10 wt % in polyol) of hyaloclastite of basaltic chemical compositions filler of 40 μm volume-based mean particle size is added to the polyisocyanurate foam ingredients mix with a ratio between the PIR/PUR of 2.48

A polyisocyanurate foam composition comprising an isocyanate reactive compound, a polyisocyanate, blowing agent and hyaloclastite of basaltic chemical composition filler component, wherein the amount of hyaloclastite filler in the composition ranges from 0.5 to about 60 wt % based upon the weight of isocyanate reactive compound, and the particle size of the hyaloclastite of basaltic chemical composition filler has a volume-based mean particle size of approximately 2 μm to approximately 60 μm. The composition comprises an isocyanate reactive compound, polyisocyanate, blowing agent and mica filler component.

Expandable polystyrene foam compositions are well known in the art. The present invention also provides processes for producing expandable styrene polymers and also provides the expanded polystyrene foams produced therefrom. For the purposes of the present invention, expandable styrene polymers are styrene polymers containing blowing agents. The polymer matrix present in the expandable styrene polymers of the present invention is, in particular, homopolystyrene or a styrene copolymer containing up to 20%, based on the weight of the polymers, of ethylenically unsaturated comonomers, in particular alkylstyrene, divinylbenzene, acrylonitrile or C-methylstyrene. Blends of polystyrene and other polymers, in particular with rubber and polyphenylene ether are also possible. The styrene polymers can contain the customary and known auxiliaries and additives, for example flame retardants, nucleating agents, UV stabilizers, chain transferrers, blowing agents, plasticizers, pigments and antioxidants. The expandable particles are coated with the customary and known coating materials, for example metal stearates, glyceryl esters and finely divided silicates. The particle polystyrene bead size is preferably in the range 0.2-2 μmm. The hyaloclastite, or lava quenched by water, mineral filler used preferably has a volume-based mean particle size of approximately 1 μm to approximately 60 μm, more particular approximately 2 μm to approximately 40 μm, more particular approximately 4 μm to approximately 20 μm, most particular approximately 2 μm to approximately 16 am, a specific density of 2.6 to 3.1 g/cm³ and a specific surface area of 5 to 2000 μm/g. The hyaloclastite or lava quenched by water mineral filler particles are preferably present in the styrene polymer in amounts of from 0.05 to approximately 50% by weight, more particular from 1 to approximately 25% by weight, in particular from 2 to approximately 10% by weight. Surprisingly, it has been found that hyaloclastite or lava quenched by water mineral filler particles are effective even in amounts of less than 0.5% by weight.

Other fillers, such as graphite, have been used in polystyrene. However, a problem associated with the use of graphite particles is the ready flammability of the expanded polystyrene foams containing such graphite particles. Thus, graphite-containing polystyrene foams have hitherto not been able to pass the burning tests required for use in building and construction. To rectify this defect, flame retardants, particularly ones based on organic bromine compounds, are added to the expandable styrene polymers. The hyaloclastite, or lava quenched by water, mineral filler is non-flammable, thermally stable filler that not only will not increase the flammability of the styrene, such as graphite or carbon black do, but in fact decreases the flammability and flame spread and increases the thermal stability of the polystyrene. These properties result in a reduction or elimination of the need of flame retardants currently used in the polystyrene manufacturing process. The type of additional fillers that may be used is not a critical aspect of the present invention and other additional fillers known in the art may be used.

Flame retardants can still be used, if so desired, in polystyrene manufacture in accordance with the present inventions. Such flame retardants include, but, are not limited to, bromine compounds (without a synergist) should be added in an amount of more than 3% by weight, based on the weight of the expandable styrene polymers. Tests B1 and B2 are not passed when the customary amount of flame retardant is used. The organic bromine compounds should have a bromine content of 270% by weight. Surprisingly, this amount of flame retardants leads to no deterioration whatsoever in the mechanical properties of the expanded polystyrene foams containing carbon black. Particularly suitable flame retardants are aliphatic, cycloaliphatic and aromatic bromine compounds, for example hexabromocyclododecane, pentabromomonochlo rocyclohexane and pentabromophenyl allyl ether. The effect of the bromine-containing flame retardants is considerably improved by addition of C—C- or O—O-labile organic compounds. Examples of suitable flame retardant synergists are bicumyl and dicumyl peroxide. A preferred combination comprises 0.6 to 5% by weight of an organic bromine compound and 0.1 to 1.0% by weight of the C-CorO-O-labile organic compound. The type of flame retardant used is not a critical aspect of the present invention and other flame retardant materials known in the art can be used.

The expandable styrene polymers of the present invention can be produced by various methods. In a preferred embodiment, the hyaloclastite, or lava quenched by water, mineral filler particles in accordance with the present invention are mixed with a melt of the styrene polymer, preferably in an extruder. At the same time, a blowing agent is metered into the melt. The hyaloclastite, or lava quenched by water, mineral filler particles can also be compounded into the melt of styrene polymer containing blowing agent; in this case, it is convenient to use oversize and undersize fractions of polystyrene beads containing blowing agent formed in a suspension polymerization. The polystyrene melt containing blowing agents and hyaloclastite, or lava quenched by water, mineral filler particles is extruded and granulated to form granules containing blowing agent. Since hyaloclastite, or lava quenched by water, mineral filler has a strong nucleating action, the compounded polystyrene should be quickly cooled under pressure after extrusion in order to avoid foaming. For this reason, an underwater granulation under pressure is advantageously carried out. It is also possible to add the blowing agent to styrene polymers containing hyaloclastite, or lava quenched by water, mineral filler particles in a separate process step. Here, the granules are impregnated with the blowing agent, preferably in aqueous suspension. In all three cases, the finely divided hyaloclastite, or lava quenched by water, mineral filler particles can be added directly to the polystyrene melt. The hyaloclastite, or lava quenched by water, mineral filler particles can also be added in the form of a concentrate in polystyrene. However, preference is given to introducing polystyrene granules and hyaloclastite, or lava quenched by water, mineral filler particles together into an extruder, melting the polystyrene and mixing it with the hyaloclastite, or lava quenched by water, mineral filler. It is in principle also possible to incorporate the hyaloclastite, or lava quenched by water, mineral filler particles during the course of the suspension polymerization. Here, they can be added prior to suspending the monomeric styrene or added to the reaction mixture during the course of the polymerization, preferably during the first half of the polymerization cycle. The blowing agent is also preferably added during the course of the polymerization, but it can also be incorporated into the styrene polymer afterwards. It is preferred to start with a ratio from a 0.5-30% strength by weight, in particular from 5 to 20% strength by weight, solution of polystyrene in styrene. This can be achieved by dissolving fresh polystyrene in monomers, but use is advantageously made of oversize and undersize fractions which have been sieved out in the fractionation of the variously sized beads obtained in the preparation of expandable polystyrene. In practice, such otherwise unusable oversize and undersize fractions have diameters of greater than 2.0 μmm or less than 0.2 μmm. Recycled polystyrene and recycled polystyrene foam can also be used. Another possibility is to prepolymerize styrene in bulk up to a conversion of from 0.5 to 70% and to suspend the prepolymer together with the hyaloclastite, or lava quenched by water, mineral filler particles in the aqueous phase and complete the polymerization. The blowing agent is added in the customary amounts of about 3-10% by weight, based on the weight of the polymer. Blowing agents are usually made of aliphatic hydrocarbons having from 3 to 10, preferably from 4 to 6, carbon atoms. The type of method of making expandable polystyrene polymers used is not a critical aspect of the present invention and other methods of making expanded polystyrene polymers and be used.

The novel expandable styrene polymers containing hyaloclastite, or lava quenched by water, mineral filler also containing carbon black can be processed to produce polystyrene foams with densities of 5-35 g/l, preferably from 8 to 25 g/l and in particular 10-15 g/l. For this purpose, the expandable particles are prefoamed. This is usually achieved by heating the particles by means of steam in prefoamers. The particles which have been prefoamed in this way are then fused or welded together in desired shape moldings. For this purpose, the prefoamed particles are introduced into molds which do not close in a gastight manner and are treated with steam to create various elements. After cooling, the elements can be taken from the mold. A further effect of the addition of hyaloclastite, or lava quenched by water, mineral filler particles is that it can reduce the cooling time until welded foam blocks or elements can be removed from the mold. Thus, for example, an addition of from 0.5 to 50% by weight of hyaloclastite, or lava quenched by water, mineral filler leads to a shortening of from 10 to 90% in the cooling time. The foams produced from the expandable styrene polymers of the present invention have an excellent thermal insulation capacity, improved thermal stability, flame spread and fire resistance properties. This effect is particularly distinct at low densities. Thus, addition of 2% by weight of hyaloclastite, or lava quenched by water, mineral filler to an expandable styrene polymer enables the thermal conductivity at a foam density of 10 g/l to be reduced. The present invention further provides expanded polystyrene foams which have a density of <35 g/l and contain from 0.05 to 25% by weight of homogeneously distributed hyaloclastite, or lava quenched by water, mineral filler graphite particles and whose thermal conductivity is reduced sufficiently for the foams to meet the requirements of thermal conductivity code requirements and are preferably self-extinguishing and pass the burning test code requirements. The ability to reduce the density of the styrene polymers significantly at the same thermal conductivity allows material savings to be realized. Since, compared to conventional expandable styrene polymers, the same thermal insulation performance can be achieved at significantly lower densities, the expandable polystyrene particles produced according to the present invention makes it possible to use thinner foam boards, which makes a space saving possible. The expandable styrene polymers of the present invention can be processed without any problems at all to give low-density foams. There are neither blowing agent losses nor disruptions of the cell structure of the foams, although a person skilled in the art would have to assume that the graphite would act as nucleating agent and lead to undesirably fine cells in the foam and poor welding together. In addition, the present invention produces self-extinguishing foams which pass the burning test code requirement. The foams of the present invention can be used for thermal insulation of buildings and parts of buildings, for thermal insulation of machines and domestic appliances and also as packaging materials. The invention is illustrated in more detail by the examples below. Parts and percentages are by weight.

### Example 15

In a pressure-resistant stirred vessel, 0.498 kg of oversize/undersize EPS is dissolved in 16.6 kg of styrene. 16.6 g of hyaloclastite mineral filler powder; i.e., 0.1% of hyaloclastite mineral filler powder based on the total amount of styrene and EPS, is homogeneously suspended in the solution and 83.0 g of dicumyl peroxide, 4.15 g of dibenzoyl peroxide and 112.033 g of hexabromocyclododecane (HBCD) is added. The organic phase is introduced into 19.31 of deionized water in a 501 stirred vessel. The aqueous phase comprises 46.127 g of sodium pyrophosphate and 86.348 g of magnesium sulfate (Epsom Salts). The suspension is heated to 80° C. over a period of 140 μminutes. 2.32 g of emulsifier K30/40 (Bayer AG) is then added. After a further 40 μminutes, 1330 g of pentane is metered in and the polymerization is completed at 126° C. Separating off the aqueous phase gives homogeneously grayish beads having a mean diameter of 1.18 μmm. Prefoaming the beads twice using steam results in a bead density of 10.0 g/1. The internal water content is <1.5% and the residual styrene content is <1000 ppm. The prefoamed beads are welded together by means of steam to make foam blocks. The thermal conductivity at a density of 10 g/l is then measured.

### Example 16 Comparison

Example 15 is repeated without addition of hyaloclastite mineral filler powder. The thermal conductivity at a density of 10 g/l is then measured. The thermal conductivity of the foam block in Example 16 is greater than the thermal conductivity of the foam block in Example 15.

### Example 17

In a pressure-resistant stirred vessel, a mixture of 150 parts of deionized water, 0.1 part of sodium pyrophosphate, 100 parts of styrene, 0.45 part of benzoyl peroxide, 0.15 part of tert-butyl perbenzoate and 5 parts of hyaloclastite mineral filler powder, 2 parts of hexabromocyclododecane (HBCD) and 0.4 part of dicumyl peroxide is heated to 90° C. while stirring. After 2 hours at 90° C., 4 parts of a 10% strength aqueous solution of polyvinylpyrrolidone is added. The mixture is then stirred for another 2 hours at 90° C. and 7 parts of a mixture of 80% of n-pentane and 20% of iso-pentane were added. The mixture is subsequently stirred for 2 hours at 110° C. and finally for 2 hours at 140° C. The expandable polystyrene beads obtained are washed with deionized water, sieved to 0.7-1.0 μmm and subsequently dried using warm air. The beads are prefoamed by treatment with flowing steam and, after storage for one day, are fused or welded together in a closed mold by means of further treatment with steam to give foam blocks having a density of 15 g/1. The measurement of the thermal conductivities is then carried out at 10° C.

### Example 18

2.55 kg of polystyrene (PS 158 K from BASF) are dissolved in 17.03 kg of styrene. 196 g of hyaloclastite mineral filler powder; i.e., 6% of hyaloclastite based on the total amount of styrene and polystyrene, are homogeneously suspended in the solution and 59.6 g of dicumyl peroxide and 20.4 g of dibenzoyl peroxide are added. The organic phase is introduced into 19.51 of deionized water in a 501 stirred vessel. The aqueous phase comprises 69.8 g of sodium pyrophosphate and 129.5 g of magnesium sulfate. 195.8 g of pentane are metered into the suspension which is then heated to 80° C. After 140 μminutes, 3.51 g of emulsifier K30/40 (Bayer AG) are added. After a further 30 μminutes, another 1175.1 g of pentane are metered in and polymerization is completed at 134° C. Separating off the aqueous phase gives homogeneously hyaloclastite filled beads having a mean diameter of 0.82 μmm. The beads can be foamed using steam to give a density of 10.2 g/l after 3 μminutes. The measurement of the thermal conductivity is then carried out on foam blocks at 10° C.

### Example 19

Example 18 is repeated using 4% of hyaloclastite mineral filler powder.

### Example 20

Example 18 is repeated using 2% of hyaloclastite mineral filler powder.

### Example 21

Example 18 is repeated using 1% of hyaloclastite mineral filler powder.

### Example 22

Example 18 is repeated using 0.5% of hyaloclastite mineral filler powder.

### Example 23

Example 18 is repeated using 0.2% of hyaloclastite mineral filler powder.

### Examples 24, 25, 26, 27, 28, 29 and 30

Polystyrene having a mean molecular weight (M) of 220,000 (PS 148 H BASF) and containing 2.1% of HBCD and 0.42% of bicumyl is plasticized at 180° C. with addition of an amount of hyaloclastite mineral filler powder of 6%, 4%, 2%, 1%, 0.5%, 0.2% and 0% respectively as a 20% strength masterbatch in polystyrene in a heated twin screw extruder and extruded through a die plate having a 1 μmm diameter orifices. The extrudates are solidified in a water bath and subsequently granulated to a particle size of 2×2×2 μmm by means of rotating knives. 6000 g of these granules together with 21,300 g of deionized water, 76 g of sodium pyrophosphate, 155 g of magnesium sulfate heptahydrate and 50 g of a 40% strength solution of an alkylbenzenesulfonate (Mersolat K30, Bayer AG) are placed in a 50 l capacity stirred vessel. The vessel is closed and heated to 120° C. while stirring at 250 rpm. After this temperature is reached, 500 g of a mixture of 80% of n-pentane and 20% of iso-pentane are injected into the vessel over a period of 15 μminutes and the mixture is stirred for another 6 hours at 120° C. The expandable beads obtained are washed, sieved to 0.7-1 μmm, dried and processed to form foam blocks. At a density of 10.1 g/l, the thermal conductivity is then measured.

### Examples 31, 32, 33 and 34

In a heated twin-screw extruder, 2% of hyaloclastite mineral filler powder and 5.0% of a mixture of 80% of n-pentane and 20% of iso-pentane are metered into molten polystyrene having a mean molecular weight (M) of 220,000 and containing 2.1% of HBCD and 0.42% of bicumyl at a melt temperature of about 160° C. The homogenized mixture is at a melt temperature of 180° C., extruded through a die plate having 0.8 μmm diameter orifices. An underwater granulator is fitted to the die plate. The melt coming out of the die is granulated at a pressure of 5 bar by means of a rotating knife. Beads having a diameter of 1.5 μmm are obtained. In Example 31, foaming is carried out to a density of 10.3 g/l and in Example 32 (shorter steam treatment time) to a density of 15 g/l. The thermal conductivities are then measured.

In Example 33, the flame retardant is left out and in Comparative Example 34 both the flame retardant and the hyaloclastite mineral filler powder are left out. The thermal conductivities is then measured.

Polymeric materials using a mineral filler in powder form made from hyaloclastite mineral filler powder in accordance with the present invention have enhanced properties such as improved friability, rigidity, hardness, fire resistance, flame spread and thermal properties. Physical properties such as compressive, flexural and tensile strength are improved by the use of such fillers in polyurethane foams or rigid products. Hyaloclastite mineral filler powder contributes to a decrease of the heat release rate, thereby showing improved thermal stability, flame spread and fire resistance of the polymeric materials using this type of mineral filler. Polymeric foams using the hyaloclastite mineral filler powder also show self-extinguishing properties.

Extruded polystyrene foam production is well known in the art. A method for the production of an extruded, polystyrene based foam board according to the present invention includes extruding a foamable molten composition containing a polystyrene-based resin, a hyaloclastite or lava quenched by water mineral filler, a blowing agent, a flame retardant, a nucleating agent through a die from a high-pressure zone to a lower pressure zone.

The blowing agent used in the present invention can be of any type known to a person with knowledge in the art. It can comprise, consist essentially of or consist of the following ingredients (a)-(d): Ingredient (a): not smaller than 25% by weight but not greater than 65% by weight, based on the total weight of the blowing agent, of saturated hydrocarbons including isobutane. Ingredient (b): not smaller than 5% by weight but not greater than 70% by weight, based on the total weight of the blowing agent, of ethers including dimethyl ether. Ingredient (c): not smaller than 5% by weight but not greater than 55% by weight, based on the total weight of the blowing agent, of carbon dioxide. Ingredient (d) which is an optional ingredient: 0-25% by weight, based on the total weight of the blowing agent, of other blowing agent components.

More particularly, in the method for production of the extruded foam board according to the present invention, a polystyrene-based resin, the hyaloclastite, or lava quenched by water, mineral filler powder and additives such as a flame retardant and a nucleating agent is charged in an extruder and kneaded with heating to obtain a molten resin mixture. The molten resin mixture is then mixed with a blowing agent known to a person in the industry or having the above composition under a high pressure to obtain a foamable molten composition. After the temperature of the foamable molten composition has been adjusted to a temperature suitable for foaming, the foamable molten composition is extruded from a high-pressure zone to a lower pressure zone through a die attached to an end of the extruder. The extruded foam board produced by the method has a large thickness and can be adjusted from a lower to a higher apparent density. The extruded polystyrene board in accordance with the present invention has excellent thermal stability, flame spread retardancy and heat insulating properties. The type of method used for the production of the extruded polystyrene used is not a critical aspect of the present invention and other methods for producing extruded polystyrene known in the art can be used.

Suitable examples of the polystyrene-based resin mixed with hyaloclastite mineral filler powder for use in the present invention include styrene homopolymers, and copolymers mainly composed of styrene such as a styrene acrylic acid copolymer, a styrene-methacrylic acid copolymer, a styrene-maleic anhydride copolymer, a styrene-butadiene copolymer, a styrene-acrylonitrile copolymer, an acrylonitrile-butadiene-styrene terpolymer and a high-impact polystyrene. These homopolymers and copolymers may be used alone or in combination with two or more thereof. The styrene-based copolymers preferably comprise styrene monomeric units of at least 50 mol %, and more preferably at least 80 mol %.

The polystyrene-based resin for use in the present invention preferably has a melt flow rate (MFR) in the range of 0.5-30 g/10 μmin. More preferable is the use of a polystyrene-based resin having a melt flow rate in the range of 1-10 g/10 μmin because excellent extrusion mold ability can be obtained in producing the extruded foam board and because the resulting extruded foam board can have high mechanical strengths. If desired, the polystyrene-based resin can be used as a mixture with another polymer or copolymer such as a polyolefin resin or a styrene-based elastomer as long as the object and effect of the present invention is not adversely affected. The amount of such additional polymer or copolymer is not more than 30 parts by weight per 100 parts by weight of the polystyrene-based resin. In the present invention, the use of a non-linear polystyrene-based resin containing monomer units each having 1-4 branch points is preferred. Such a non-linear polystyrene-based resin has good kneadability with a mixed blowing agent containing carbon dioxide, and the use of which can lower the pressure within the die at the time of extrusion and makes it possible to produce an extruded foam board which is excellent in appearance and mechanical strengths and which has the desired apparent density.

The method for production of an extruded foam board according to the present invention is characterized by the use of a suitable type of blowing agent. Specifically, a type of blowing agent comprised of a saturated hydrocarbon including isobutane (Ingredient (a)), an ether including dimethyl ether (Ingredient (b)), and carbon dioxide (Ingredient (c)), and is free of chlorofluorocarbons or fluorocarbons can be used. The saturated hydrocarbon used as Ingredient (a) of the blowing agent in the present invention includes isobutane. The saturated hydrocarbon blowing agent can be composed of isobutane alone or two or more saturated hydrocarbons including isobutane. Suitable examples of saturated hydrocarbons other than isobutane include ethane, propane, n-butane, isopentane, cyclopentane and n-pentane. The amount of the saturated hydrocarbons other than isobutane is preferably not greater than 10% by weight, more preferably not greater than 5% by weight, and especially preferably not greater than 3% by weight, based on the total weight of the saturated hydrocarbon blowing agent. From the viewpoint of the ability of maintaining heat insulating property of the resulting extruded foam board, the saturated hydrocarbon blowing agent is preferably composed of isobutane alone. The ether used Ingredient (b) of the blowing agent includes dimethyl ether. The ether blowing agent in the blowing agent can be composed of dimethyl ether alone or two or more ethers including dimethyl ether. Suitable examples of ethers other than dimethyl ether include diethyl ether, methyl ethyl ether, and methyl vinyl ether. The ethers other than dimethyl ether are preferably used in an amount of not greater than 80% by weight, more preferably not greater than 50% by weight, and especially preferably not greater than 30% by weight, based on the total weight of the ether blowing agent. From the viewpoint of solubility to the polystyrene-based resin and easiness in handling, the ether blowing agent in the mixed blowing agent is preferably composed of dimethyl ether alone. In addition to the saturated hydrocarbons, ethers and carbon dioxide, other blowing agent components (Ingredient (d)) can be optionally incorporated into the blowing agent, if desired. Suitable examples of the other blowing agent components include an alkyl chloride, such as methyl chloride and ethyl chloride, an alcohol, such as methanol and ethanol, water, and an inorganic gas, such as nitrogen; and ketone. The following effects can be obtained by the use of the other blowing agent components. When an alkyl chloride is substituted for a part of the ether blowing agent, for example, a risk of an ignition incident in producing the extruded foam board can be reduced. When an alkyl chloride is used as a substitute for a part of the saturated hydrocarbon blowing agent, the flame retardancy of the resulting extruded foam board can be improved. However, for the purpose of the present invention, the amount of the other blowing agent component (Ingredient (d) can be 0% by weight.

In the blowing agent, the above ingredients are used in specific amounts. Namely, the amount of the isobutene containing saturated hydrocarbon (Ingredient (a)) should not be smaller than 25% by weight but should not be greater than 65% by weight, based on the total weight of the blowing agent. When the content of Ingredient (a) is less than 25% by weight, the resulting extruded foam board has a poor heat insulating property. When the content of Ingredient (a) is over 65% by weight, it is difficult to obtain a sufficient inflammability stability. Thus, there arises a need to employ a special cell structure in which cells of large and small diameters are mingled and a special flame retardant. The amount of dimethyl ether-containing ether (Ingredient (b)) should not be smaller than 5% by weight but should not be greater than 70% by weight, based on the total weight of the blowing agent. When the content of Ingredient (b) is less than 5% by weight, it is difficult to obtain an extruded foam board having a low apparent density, resulting in poor lightness and a poor heat insulating property. When the content of Ingredient (b) is over 70% by weight, the resulting extruded foam board has a poor heat insulating property, and a risk of an ignition incident in production thereof may be increased. The amount of carbon dioxide (Ingredient (c)) should not be smaller than 5% by weight but should not greater than 55% by weight, based on the total weight of the blowing agent. When the content of Ingredient (c) is less than 5% by weight, it is difficult to form cells having a small average diameter in the resulting extruded foam board and an effect of improving the flame retardancy and heat insulating property of the extruded foam board cannot be expected. When the content of Ingredient (c) is over 55% by weight, it is difficult to obtain an extruded foam board having a low apparent density. The amount of other blowing agent components (Ingredient (d)) should be in the range of 0-25%, preferably 0-10% by weight, and more preferably 0-5% by weight, based on the total weight of the blowing agent. The weight of the blowing agent is not essential to the present invention and may be of any weight suitable to the manufacture of the insulation board.

A nucleating agent, which is an additive for controlling the average diameter of cells in the extruded foam board, inorganic particles such as particles of talc, kaolin, mica, silica, calcium carbonate, barium sulfate, titanium oxide, clay, aluminum oxide, bentonite, or diatom earth can be used. The nucleating agents can be used alone or in combination. Among the above examples, talc particles are preferably employed for reasons of easiness to control the cell diameter and freedom of inhibiting the flame retardancy. Especially preferable is the use of talc particles having an average diameter of 0.1-10 um, more preferably 0.5-5 um. Talc particles are preferably used in an amount of 1-10% by weight, more preferably 1.5-8% by weight, and most preferably 2-7% by weight, per 100 parts by weight of the extruded foam board. When the amount of the talc particles is in the above range, an effect of improving flame retardancy can be obtained in addition to the effect of making the cell diameter small. Alternatively, hyaloclastite or lava quenched by water mineral filler of much finer particle size can also be used as a nucleating agent. Especially preferable is the use of hyaloclastite or lava quenched by water mineral filler particles having an average diameter of 0.1-10 μm, more preferably 0.5-5 μm. Hyaloclastite or lava quenched by water mineral filler particles are preferably used in an amount of 1-30% by weight, more preferably in the amount of 1-20% by weight, more preferably 1.5-16% by weight more preferably 1.5-8% by weight, and most preferably 2-7% by weight, per 100 parts by weight of the extruded foam board. In the method of the present invention, additives such as colorant, a thermal stabilizer and any other filler can be used in addition to the nucleating agent and the flame retardant, as desired, to the extent that it will not inhibit the purpose of the present invention.

The polystyrene-based resin, the hyaloclastite or lava quenched by water mineral filler, the nucleating agent and the flame retardant (and other additives, or fillers if desired) are heated and kneaded in an extruder. With the addition of the blowing agent, the kneaded mixture is further heated and kneaded to obtain a foamable molten composition. On cooling to a temperature suitable for foaming, the foamable molten composition is continuously extruded from a high-pressure zone to a lower pressure zone through a die lip and shaped into a board form while it is foaming. More specifically, the foamable molten composition extruded through the die lip is passed through a shaping device while it is foaming to shape it into a board form. The extruded foam board of the present invention, which has cells of a smaller diameter in the thickness direction of the board as compared with conventional foam boards, can be obtained by using a specific amount of carbon dioxide as one of the components of the blowing agent and adding a nucleating agent to the base resin. The extruded foam board having cells having average diameters a, b and c satisfying the relations (1) and (2) can be obtained with ease by passing the foamable molten composition through a below-mentioned passage of a shaping device having a specific structure while it is foaming. The temperature suitable for foaming is in the range in which the foamable molten composition exhibits a viscosity suitable for foaming. The suitable temperature varies depending upon the type of the polystyrene-based resin used, presence or absence of a fluidity improver (when used, the type and amount thereof), and the amount and composition of the blowing agent. In a case where polystyrene homopolymer is used as the polystyrene-based resin, for example, the suitable foaming temperature is generally 110-130° C.

### Example 35

The following ingredients are used: 100 parts by weight of polystyrene, 8.3 parts by weight of nucleating agent (a master batch composed of 69% by weight of the same polystyrene as above, 30% by weight of hyaloclastite mineral filler average diameter: 2.5 μm um) and 1% by weight of zinc stearate), a mixture of 3 parts by weight of hexabromocyclododecane and a small amount of stabilizer as a flame retardant, and a blowing agent prepared by mixing isobutane, dimethyl ether and carbon dioxide in proportions known to a person in the art. Such compound are extruded through an extruder having a diameter of 65 μmm (which will be hereinafter referred to as “first extruder”), an extruder having a diameter of 95 μmm (which will be hereinafter referred to as “second extruder”) and an extruder having a diameter of 150 μmm (which will be hereinafter referred to as “third extruder”) connected in series are used. The blowing agent is injected into the molten resin at a position near the downstream end of the first extruder. A die lip having a resin discharge port having a width of 115 μmm and a lip gap of 1.5 μmm (rectangular cross-section) at an end thereof is used. At the end of the die lip is attached a type-C passage which is defined by upper, lower, right and left walls made of polytetrafuluoroethylene and in which the distance between the upper and lower walls is once enlarged and then narrowed from the entrance toward the exit. A shaping device with upper and lower plates made of polytetrafluoroethyrene and is attached to the type-C passage known to a person in the art. The ingredients including the polystyrene-based resin are kneaded in the first extruder at 220° C. The blowing agent is injected into the kneaded mixture at a position near the downstream end of the first kneader to obtain a foamable molten composition which is subsequently passed successively through the second and third extruders. During the passage through the second and third extruders, the foamable molten composition is gradually cooled. The foamable molten composition is then extruded through the die lip at an extrusion rate known to a person in the art, while maintaining the temperatures of the die and the die lip at 120° C. and 110° C., respectively. In this case, the pressure of the foamable molten composition in the die is maintained at 40 kgf/cm.

The foamable molten composition extruded from the die lip is compressed and allowed to foam during its passage through the passage and then allowed to fill in the shaping section to shape it into an insulation board shape, thereby obtaining an extruded foam board. The extrusion rate at that time is chosen to facilitate such extrusion process and known to a person in the industry. The apparent density, thickness, closed cell content, average cell diameter in the thickness direction of the foam board, cell deformation rate, thermal conductivity, flammability, and residual amount of blowing agent of the thus obtained extruded foam board are measured upon completing of the process. The extruded foam boards obtained in the above example has a thickness of 26 μmm and a width of 240 μmm.

### Example 36

An extruded foam board is produced in the same manner as that in Example 34, except that 10 parts of hyaloclastite mineral filler powder with a volume-based mean particle size of 20 μm are added to the following ingredients used in example 1: 100 parts by weight of polystyrene, 8.3 parts by weight of nucleating agent (a master batch composed of 69% by weight of the same polystyrene as above, 30% by weight of hyaloclastite mineral filler powder with an average diameter: 2.5 μm) and 1% by weight of zinc stearate), a mixture of 3 parts by weight of hexabromocyclododecane and a small amount of stabilizer as a flame retardant, and a blowing agent prepared by mixing isobutane, dimethyl ether and carbon dioxide in proportions known to a person in the art. The apparent density, thickness, closed cell content, average cell diameter in the thickness direction of the foam board, cell deformation rate, thermal conductivity, flammability, and residual amount of blowing agents of the thus obtained extruded foam board is then measured.

### Example 37

An extruded foam board is produced in the same manner as that in Example 34, except that 20 parts of hyaloclastite mineral filler powder with a volume-based mean particle size of 20 μm are added to the following ingredients used in Example 1: 100 parts by weight of polystyrene, 8.3 parts by weight of nucleating agent (a master batch composed of 69% by weight of the same polystyrene as above, 30% by weight of hyaloclastite mineral filler powder having an average diameter: 2.5 micron) and 1% by weight of zinc stearate), a mixture of 3 parts by weight of hexabromocyclododecane and a small amount of stabilizer as a flame retardant, and a blowing agent prepared by mixing isobutane, dimethyl ether and carbon dioxide in proportions known to a person in the art. The apparent density, thickness, closed cell content, average cell diameter in the thickness direction of the foam board, cell deformation rate, thermal conductivity, flammability, and residual amount of blowing agents of the thus obtained extruded foam board is then measured.

### Examples 38

An extruded foam board is produced in the same manner as that in Example 34, except that the nucleating agent is a master batch composed of 69% by weight of the same polystyrene as Example 34, 30% by weight of talc with average dimeter of 2.5 micron and 1% by weight of zinc stearate instead of using the hyaloclastite mineral filler in the master batch. The apparent density, thickness, closed cell content, average cell diameter in the thickness direction of the foam board, cell deformation rate, thermal conductivity, flammability, and residual amount of blowing agents of the thus obtained extruded foam board is then measured.

### Example 39

An extruded foam board is produced in the same manner as that in Example 37, except that the nucleating agent master batch is changed to 16.7 parts by weight. The apparent density, thickness, closed cell content, average cell diameter in the thickness direction of the foam board, cell deformation rate, thermal conductivity, flammability, and residual amount of blowing agents of the thus obtained extruded foam board is then measured.

### Example 40

An extruded foam board was produced in the same manner as that in Example 38, except that 10 parts of hyaloclastite mineral filler with a volume-based mean particle size of 20 microns are added to the following ingredients used in Example 1: 100 parts by weight of polystyrene, 8.3 parts by weight of nucleating agent (a master batch composed of 69% by weight of the same polystyrene as above, 30% by weight of hyaloclastite mineral filler having a volume-based mean particle size of 2.5 micron) and 1% by weight of zinc stearate), a mixture of 3 parts by weight of hexabromocyclododecane and a small amount of stabilizer as a flame retardant, and a blowing agent prepared by mixing isobutane, dimethyl ether and carbon dioxide in proportions known to a person in the art. The apparent density, thickness, closed cell content, average cell diameter in the thickness direction of the foam board, cell deformation rate, thermal conductivity, flammability, and residual amount of blowing agents of the thus obtained extruded foam board is then measured.

### Example 41

An extruded foam board is produced in the same manner as that in Example 38, except that 20 parts of hyaloclastite mineral filler with a volume-based mean particle size of 20 microns are added to the following ingredients used in Example 1: 100 parts by weight of polystyrene, 8.3 parts by weight of nucleating agent (a master batch composed of 69% by weight of the same polystyrene as above, 30% by weight of hyaloclastite mineral filler having a volume-based mean particle size of 2.5 μm) and 1% by weight of zinc stearate), a mixture of 3 parts by weight of hexabromocyclododecane and a small amount of stabilizer as a flame retardant, and a blowing agent prepared by mixing isobutane, dimethyl ether and carbon dioxide in proportions known to a person in the art. The apparent density, thickness, closed cell content, average cell diameter in the thickness direction of the foam board, cell deformation rate, thermal conductivity, flammability, and residual amount of blowing agents of the thus obtained extruded foam board are then measured.

The polystyrene in accordance with this invention can be used to manufacture insulating foam boards. The manufacture of foam boards may require the use of facers. Facings for use in the present invention include any flat, sheet material suitable to the required end application of the final board product. At least the upper facer must be flexible enough to be wrapped tightly around a metering roll. Facers must also be flat enough to not significantly alter the small gap between metering rolls. Such materials include, but are not limited to, aluminum foil/kraft paper laminations, bare aluminum foil, paper roof insulation facings, and coated glass fiber mats. A facer, as used herein, can also include plywood, oriented strandboard or gypsum, in which case such rigid material is conveyed to the laminator, and foam-forming mixture is preferably applied directly thereon. Alternatively, panel facers can be made of metal sheets, such as steel or aluminum, to create a structural or non-structural insulated metal panel.

The polystyrene in accordance with this invention can be used to make any other type of rigid polymeric plastic object such as open or closed cell mats, membranes, foams, plastic components or the like.

Polymeric materials using a mineral filler in powder form made from hyaloclastite or lava quenched by water in accordance with the present invention have enhanced properties such as improved friability, rigidity, hardness, fire resistance, flame spread and thermal properties. Physical properties such as compressive, flexural and tensile strength are improved by the use of such fillers in polyurethane foams or rigid products. Hyaloclastite or lava quenched by water mineral filler in accordance with the present invention contributes to the decrease of the heat release rate, thereby showing improved thermal stability, flame spread and fire resistance of the polymeric materials using this type mineral filler. Polymeric materials using hyaloclastite, or lava quenched by water, mineral filler in accordance with the present invention also show self-extinguishing properties.

Hyaloclastite, or lava quenched by water, fillers of basaltic or intermediate-basaltic chemistry in accordance with the present invention can be also used as fillers in thermosetting and thermoplastic resins. The term “plastic” is intended to include any natural or synthetic polymeric material, such as thermosetting, thermoplastic or thermoplastic resins, which can be molded or extruded into a desired final shape using heat and/or pressure. Thermoplastic resins can be molded or extruded with or without a foaming agent. The thermoplastic manufacturing method is intended to include any plastic forming process such as film formation by extrusion, casting, or calendering, blow molding, injection molding, extrusion, vacuum forming, pressure forming, compression molding, transfer molding, and the like.

The thermoplastic resin component useful in the present invention can be selected from one or more of the acrylonitrile butadiene styrene (ABS), acrylic-styrene-acrylonitrile (ASA) and other specialist styrenics, aramids PI aromatic polyamide, cellulosics (CA, CAB, CAP, CN), ethylene vinyl acetate (EVA), expanded polystyrene (EPS), expanded polypropylene (EPP), fluoroplastics (PTFE FEP), nylons (polyamides) (PA, PEEK™) (polyaryletheretherketone), polybenzimidazole (PBI), polybutene-1 (PB-1), polycarbonate (PC), polyether sulfone (PES), polyoxymethylene (POM), polyacetals, polyether ether ketone (PEEK), polyetherimide (PEI), polyesters (thermoplastic) (PETP, PBT, PET), polyethylene (PE), polyethylene (High Density) (HDPE), polyethylene (Low Density) (LDPE, LLDPE), polyethylenetheraphthalate (PET), polypropylene (PP), polyphenylene oxide (PPO), polyphenylene sulphide (PPS), polymethylpentene (PMP), polystyrene (PS), polystyrene (General Purpose) (GPPS), polystyrene (High Impact) (HIPS), poly(vinyl alcohol) (PVOH, PVA, or PVAI), polyvinyl chloride (PVC), styrene acrylonitrile (SAN), acrylonitrile styrene acrylate (ASA), thermoplastic elastomers (TPE, TPR).

Other engineered thermoplastics or plastic blends are also suitable. Examples include polycarbonate, nylon, vinyl and blends of ABS-PVC, ABS-polycarbonate, and ABS-polyurethane. Additional examples of such materials are: ABS resins, ASA resins, ionomers, nylons, polyarylene oxides, polyolefins, styrene polymers and copolymers such as styrene butadiene, vinyl polymers and copolymers such as poly(vinyl chloride), poly(vinyl fluoride), vinylidene chloride/vinyl chloride copolymer, polytetrafluoroethylene (Teflon) and the like, including blends, and recycled or impure plastics. The base resins can be supplied in powder form or pellet form or as a blend of the two forms.

Additionally, acrylic plastics or coating can also use hyaloclastite, or lava quenched by water, filler in accordance with the present inventions. Generally there are two main acrylic types: polyacrylic acids (PAA) and its ester derivatives (PAc) and poly(methyl methacrylate) (PMMA). PMMA is also known by trade names such as Lucite, Perspex and Plexiglas. Acrylic paint consists of PMMA particles suspended in water.

Renewable plastics, such as polylactic acid (polylactide), can also use hyaloclastite mineral filler in accordance with the present invention.

Polymeric coatings and sealants such as urethane, urethane elastomeric, latex, acrylic, acrylic latex, acrylic elastomeric, epoxy, elastomeric epoxy, alkyd, silicone, silicone elastomeric and fluoropolymer based technologies and others including high performance systems based on silazanes and ceramers can also use hyaloclastite, or lava quenched by water, filler in accordance with the present inventions.

It should be understood, of course, that the foregoing relates only to certain disclosed embodiments of the present invention and that numerous modifications or alterations may be made therein without departing from the spirit and scope of the invention.

What is claimed is:

1. A product comprising a polymeric material blended with hyaloclastite having a volume-based mean particle size of less than or equal to 150 μm.

2. The product of claim 1, wherein the hyaloclastite is basaltic hyaloclastite or intermediate basaltic hyaloclastite.

3. The product of claim 2, wherein the basaltic hyaloclastite or intermediate basaltic hyaloclastite has a volume-based mean particle size of less than or equal to 100 μm.

4. The product of claim 2, wherein the basaltic hyaloclastite or intermediate basaltic hyaloclastite has a volume-based mean particle size of less than or equal to 40 μm.

5. The product of claim 2, wherein the basaltic hyaloclastite or intermediate basaltic hyaloclastite has a volume-based mean particle size of less than or equal to 20 μm.

6. The product of claim 1, wherein the polymeric material is a thermoplastic or thermosetting polymer.

7. The product of claim 1, wherein the polymeric material is a polystyrene, a polyisocyanurate or a polyurethane.

8. The product of claim 1, wherein the polymeric material is a solid polymer, a foam polymer, a rigid polymer or a flexible polymer.

9. The product of claim 1, wherein the product is an insulating board.

10. The product of claim 1, wherein the product is a carpet backing.

11. The product of claim 1, wherein the hyaloclastite comprises approximately 0.1% to approximately 20% by weight relative to polymeric material.

12. The product of claim 1, wherein the polymeric material is acrylonitrile butadiene styrene (ABS), acrylic-styrene-acrylonitrile (ASA) and other specialist styrenics, aramids PI aromatic polyamide, cellulosics (CA, CAB, CAP, CN), ethylene vinyl acetate (EVA), expanded polystyrene (EPS), expanded polypropylene (EPP), fluoroplastics (PTFE FEP), nylons (polyamides) (PA, PEEK™) (polyaryletheretherketone), polybenzimidazole (PBI), polybutene-1 (PB-1), polycarbonate (PC), polyether sulfone (PES), polyoxymethylene (POM), polyacetals, polyether ether ketone (PEEK), polyetherimide (PEI), polyesters (thermoplastic) (PETP, PBT, PET), polyethylene (PE), polyethylene (High Density) (HDPE), polyethylene (Low Density) (LDPE, LLDPE), polyethylenetheraphthalate (PET), polypropylene (PP), polyphenylene oxide (PPO), polyphenylene sulphide (PPS), polymethylpentene (PMP), polystyrene (PS), polystyrene (General Purpose) (GPPS), polystyrene (High Impact) (HIPS), poly(vinyl alcohol) (PVOH, PVA, or PVAI), polyvinyl chloride (PVC), styrene acrylonitrile (SAN), acrylonitrile styrene acrylate (ASA), thermoplastic elastomers (TPE, TPR), polycarbonates, nylons, vinyls, poly(vinyl chloride), poly(vinyl fluoride), vinylidene chloride/vinyl chloride copolymer, polytetrafluoroethylene, polyacrylic acids (PAA), poly(methyl methacrylate) (PMMA), polylactic acid, or epoxies.

13. The product of claim 1, wherein the polymeric material is polyethylene, polypropylene or polyethylenetheraphthalate.

14. A process comprising combining hyaloclastite with an uncured or unset polymeric material to thereby form a uniform mixture thereof, wherein the hyaloclastite has a volume-based mean particle size of less than or equal to 160 μm.

15. The process of claim 14, wherein the hyaloclastite is basaltic hyaloclastite or intermediate basaltic hyaloclastite.

16. The process of claim 15, wherein the basaltic hyaloclastite or intermediate basaltic hyaloclastite has a volume-based mean particle size of less than or equal to 100 μm.

17. The process of claim 15, wherein the basaltic hyaloclastite or intermediate basaltic hyaloclastite has a volume-based mean particle size of less than or equal to 40 μm.

18. The process of claim 15, wherein the basaltic hyaloclastite or intermediate basaltic hyaloclastite has a volume-based mean particle size of less than or equal to 20 μm.

19. The process of claim 15, wherein the polymeric material is a thermoplastic or thermosetting polymer.

20. The process of claim 15, wherein the polymeric material is a polystyrene, a polyisocyanurate or a polyurethane.
